(19) United States
(12) Patent Application Publication
(10) Pub. No.: US 2012/0308754 A1
(43) Pub. Date: Dec. 6, 2012

(54) Healthcare Form Assembly Having a Plurality of Removable Strips with Perforated Liner Portion

(75) Inventors: Anne M. DEHLINGER, Pendleton, NY (US); Michael J. MOORE, Amelia Island, FL (US); William BECKER, Lockport, NY (US); Rajendra G. SARDESAI, Pasadena, CA (US)

(73) Assignee: AVERY DENNISON CORPORATION, Pasadena, CA (US)

(21) Appl. No.: 13/556,867

(22) Filed: Jul. 24, 2012

Related U.S. Application Data
(63) Continuation-in-part of application No. 13/270,631, filed on Oct. 11, 2011.
Application No. 13/270,631 is a continuation-in-part of application No. 13/021,873, filed on Feb. 7, 2011.
(60) Provisional application No. 61/302,593, filed on Feb. 9, 2010.

(51) Int. Cl. G09F 3/02; B32B 7/06

(52) U.S. Cl. 428/41.8

(57) ABSTRACT

A healthcare form assembly is described which includes a carrier sheet, a release coating applied to the carrier sheet, one or more regions of pressure sensitive adhesive adjacent the release coating, and a printable facestock sheet in contact with the adhesive and being removably disposed on the carrier sheet. The printable facestock sheet includes a collection of cut lines to thereby form adhesive strips which can be readily removed from the carrier sheet. The carrier sheet includes one or more weakened separation lines that facilitate use of the healthcare assembly and in particular, removal of the adhesive strips. Particular features such as peel zones and fingerlifts are also described.

### CROSS-REFERENCE TO RELATED APPLICATIONS

The present application is a Continuation-In-Part of U.S. application Ser. No. 13/270,631 filed Oct. 11, 2011, which is a Continuation-In-Part of U.S. application Ser. No. 13/021,873 filed Feb. 7, 2011, which claims the benefit of U.S. Provisional Application No. 61/302,593 filed Feb. 9, 2010, all of which are hereby incorporated by reference in their entireties.

### FIELD

The present subject matter relates to a sheet assembly for use in providing a number of removable pre-cut adhesive strips for use in the healthcare field. The various sheet assemblies utilize perforated liners, liner portions, and/or release cuts in liners.

### BACKGROUND

The treatment of individuals in various healthcare related environments typically requires the use of a wide variety of medical devices, appliances, pharmaceuticals and other treatments. In order to reduce the possible spread of disease or contamination of the surgical or treatment theaters, typically, devices are not reused and must be disposed of once the patient or individual has been treated.

Certain treatment devices, such as IV bags, oxygen and nutritional supply tubes, catheters, monitoring device feed lines and the like require that the device be removably attached to the patient or the individual. Commonly, a piece of tape, which is often supplied from a roll, is torn from the roll supply and then applied to the tube, line or other device to secure the device to the patient. In an effort to reduce possible contamination, the remaining portion of the roll of tape is typically discarded leading to additional waste and cost in the care facility. When multiple tape sizes are required to hold or secure different appliances to the patient, then different sized rolls of tape are needed, which as noted are discarded after exposure to the treatment theater, thereby leading to additional waste and expense.

In addition, removal of tape from a tape source by a healthcare provider can also be difficult, particularly if the provider is wearing surgical or latex gloves. Typically, the leading edge of the tape is difficult to grasp by the hand or fingers of the provider due to the nature of the glove that the provider may be wearing.

What is needed therefore is an inexpensive delivery system by which a plurality of removable strips can be delivered to a treatment theater, and which strips can be easily removed and applied when needed.

### BRIEF SUMMARY

The embodiments of the present subject matter described below are not intended to be exhaustive or to limit the subject matter to the precise forms disclosed in the following detailed description. Rather, the embodiments are chosen and described so that others skilled in the art may appreciate and understand the principles and practices of the present subject matter.

In one aspect, the present subject matter provides a healthcare form assembly comprising a carrier sheet defining a leading edge and an oppositely disposed trailing edge. The healthcare assembly also comprises a release coating disposed on the carrier sheet. The healthcare assembly additionally comprises an adhesive layer disposed on the release coating. And, the healthcare assembly comprises a printable sheet having a same or substantially the same shape as the carrier sheet and being removably disposed on the carrier sheet. The printable sheet defines a first set of cut lines, and another set of transversely extending cut lines to thereby define a plurality of removable strips. The carrier sheet defines at least one weakened separation line. The weakened separation line includes a plurality of apices. And, the weakened separation line at least partially extends across at least a portion of the plurality of removable strips.

In yet another aspect, the present subject matter provides a healthcare form assembly comprising a carrier sheet including a release coating on the carrier sheet, an adhesive layer disposed on the release coating, and a printable facestock sheet having a same or substantially the same shape as the carrier sheet and being removably disposed on the carrier sheet. The facestock sheet defines a plurality of cut lines to thereby form a collection of removable strips. The collection of removable strips include at least a first strip and a second strip. The first strip and the second strip are adjacent to one another and are separated by a cut in the facestock sheet. The cut in the facestock sheet defines at least a portion of the shape of the first strip and at least a portion of the shape of the second strip. The carrier sheet defines a weakened separation line that extends under the first strip and the second strip. The healthcare form assembly is configured to be torn by a user along the weakened separation line, and thereby remove a portion of the carrier sheet from portions of both the first strip and the second strip, thereby leaving a portion of the adhesive layer of both the first strip and the second strip exposed.

In still another aspect, the present subject matter provides a healthcare form assembly comprising a carrier sheet defining a leading edge and a trailing edge which are generally parallel to one another, and a first side edge and a second side edge that are generally perpendicular to the leading edge. The healthcare assembly also comprises a release layer disposed on the carrier sheet. The healthcare assembly additionally comprises an adhesive layer disposed on the release layer. And, the healthcare assembly also comprises a printable sheet releasably disposed on the carrier sheet. The printable sheet defines a leading edge and a trailing edge which are generally parallel to one another, and a first side edge and a second side edge that are generally perpendicular to the leading edge of the printable sheet. The printable sheet defines a collection of cut lines extending substantially parallel to one of the first side edge and the second side edge of the printable sheet, thereby defining a plurality of removable adhesive strips. The carrier sheet also defines at least one weakened separation line extending under at least a portion of the removable strips.

Other features and advantages of the present subject matter will become apparent to those skilled in the art from the following detailed description. It is to be understood, however, that the detailed description of the various embodiments and specific examples, while indicating preferred and other embodiments of the present subject matter, are given by way of illustration and not limitation. Many changes and modifications within the scope of the present subject matter may be made without departing from the spirit thereof, and the subject matter includes all such modifications.

### BRIEF DESCRIPTION OF THE DRAWINGS

These, as well as other objects and advantages of this subject matter, will be more completely understood and appreciated by referring to the following more detailed description of the presently preferred exemplary embodiments of the subject matter in conjunction with the accompanying drawings, of which:

FIG. 1 depicts a top planar view of a preferred embodiment healthcare form assembly including central and peripheral peel zones according to the presently described subject matter;

FIG. 2 is a cross sectional view of the healthcare form assembly shown in FIG. 1 taken across line 2-2;

FIG. 3 illustrates an alternate configuration of the healthcare form assembly in which a central peel zone and two peripheral peel zones are provided with a plurality of finger lifts;

FIG. 4 shows removal of a removable strip from the healthcare form assembly depicted in FIG. 1;

FIG. 5 illustrates an exemplary use of a collection of removable strips from the healthcare form assembly;

FIG. 6 is an exploded view of another preferred embodiment of the healthcare form assembly of the presently described subject matter having a plurality of peel zones and fingerlifts;

FIG. 7 is a top plan view of the healthcare form assembly depicted in FIG. 6;

FIG. 8 is a cross sectional view of the healthcare form assembly depicted in FIG. 7 taken along line 8-8;

FIG. 9 is a cross sectional view of another preferred embodiment of the healthcare form assembly of the presently described subject matter having central and peripheral peel zones with fingerlifts;

FIG. 10 is a cross sectional view of yet another preferred embodiment of the healthcare form assembly of the presently described subject matter with central and peripheral peel zones and fingerlifts;

FIG. 11 is a cross sectional view of a still another preferred embodiment of the healthcare form assembly of the presently described subject matter having a peripheral peel zone and fingerlift;

FIG. 12 is a top planar view of another preferred embodiment healthcare form assembly in accordance with the present subject matter having a plurality of perforated liner portions;

FIG. 13 is a top planar view of a variation of the healthcare form assembly depicted in FIG. 12;

FIG. 14 is a detailed partial view of a front portion of the healthcare form assembly depicted in FIG. 13;

FIG. 15 is a top planar view of the healthcare assembly of FIG. 12 showing a method of use in which a portion of a liner is removed;

FIG. 16 is a detailed partial view of a rear portion of the healthcare form assembly depicted in FIG. 14;

FIG. 17 is a top planar view of the healthcare form assembly of FIG. 12 showing another method of use in which the assembly is separated into two or more portions;

FIG. 18 is a top planar view of another variation of the healthcare form assembly depicted in FIG. 12;

FIG. 19 is a top planar view of another embodiment of a healthcare form assembly according to the present subject matter;

FIG. 20 is a plan view of the back of the healthcare form assembly shown in FIG. 19;

FIG. 21 is a top planar view of a healthcare form assembly of another embodiment of the present subject matter;

FIG. 22 is a plan view of the back of the healthcare form assembly shown in FIG. 21;

FIG. 23 is an expanded plan view of another embodiment at region A-A of FIG. 21;

FIG. 24 is an expanded plan view of another embodiment at region A-A of FIG. 21;

FIG. 25 is an expanded plan view of another embodiment at region A-A of FIG. 21;

FIG. 26 is an expanded plan view of another embodiment at region A-A of FIG. 21;

FIG. 27 is an expanded plan view of another embodiment of region B-B of FIG. 21;

FIG. 28 is an expanded plan view of another embodiment at region B-B of FIG. 21;

FIG. 29 is an expanded plan view of another embodiment at region B-B of FIG. 21;

FIG. 30 is a schematic cross sectional view of a representative healthcare form assembly;

FIG. 31 is a flow chart of a manufacturing process for making a healthcare form assembly according to the present subject matter;

FIG. 32 is a plan view of the back of a healthcare form assembly of another embodiment of the present subject matter;

FIG. 33 is an expanded view of an embodiment of a release-coated liner cut used in one or more of the healthcare form assemblies;

FIG. 34 is an expanded view of another embodiment of a release-coated liner cut;

FIG. 35 is an expanded view of an another embodiment of a release-coated liner cut;

FIG. 36 is an expanded view of an another embodiment of a release-coated liner cut;

FIG. 37 is a schematic perspective view of another embodiment of a healthcare form assembly in a folded configuration;

FIG. 38 is a plan view of a front of a healthcare form assembly of another embodiment of the present subject matter;

FIG. 39 is a plan view of the healthcare assembly of FIG. 38 with a portion of the healthcare form assembly separated;

FIG. 40 is a plan view of a front of a healthcare form assembly of another embodiment of the present subject matter;

FIG. 41 is a plan view of a front of a healthcare form assembly of another embodiment of the present subject matter;

FIG. 42 is a plan view of a front of a healthcare form assembly of another embodiment of the present subject matter;

FIG. 43 is an expanded plan view of an embodiment of a series of release liner cuts of the present subject matter;

FIG. 44 is an expanded plan view of another embodiment of a series of release liner cuts;

FIG. 45 is an expanded plan view of another embodiment of a series of release liner cuts;

FIG. 46 is an expanded plan view of another embodiment of a series of release liner cuts;

FIG. 47 is an expanded plan view of a release liner cut of FIG. 46;

FIG. 48 is an expanded plan view of another embodiment of a series of release liner cuts;

FIG. 49 is an expanded plan view of a release liner cut of FIG. 48;

FIG. 50 is an expanded plan view of another embodiment of a series of release liner cuts;

FIG. 51 is an expanded plan view of a release liner cut of FIG. 50;

FIG. 52 is a plan view of a front of a healthcare form assembly of another embodiment of the present subject matter;

FIG. 53 is a plan view of a front of a healthcare form assembly of another embodiment of the present subject matter;

FIG. 54 is an expanded plan view of an embodiment at region C-C of FIG. 52;

FIG. 55 is an expanded plan view of another embodiment at region C-C of FIG. 52;

FIG. 56 is an expanded plan view of another embodiment at region C-C of FIG. 52; and

FIG. 57 is an expanded plan view of another embodiment at region C-C of FIG. 52.

Unless otherwise indicated, the illustrations in the above figures are not necessarily drawn to scale.

### DETAILED DESCRIPTION OF THE EMBODIMENTS

The various assemblies, components, and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such.

The present subject matter relates to a healthcare treatment form assembly that is suitable for use in a patient treatment theater to secure treatment appliances to an individual. The form assembly includes a laminated, pressure sensitive assembly having a plurality of uniquely sized strips that can be easily removed and applied to a patient by a care giver.

In one exemplary embodiment of the presently described subject matter, a healthcare form assembly is presented and includes a quadrate carrier sheet having first and second edges and first and second longitudinally extending sides. The quadrate sheet has top and bottom face surfaces.

A release coating is applied substantially over the top face surface of the quadrate carrier sheet. And a pattern of adhesive is applied over the release coating on the top surface of the quadrate sheet to create at least first and second adhesive areas spaced from one another in which each adhesive area has a first boundary and an opposite second boundary. First and second peel zones are provided along at least the first boundary of each of the first and second adhesive areas.

Continuing with a discussion of the presently described embodiment, a quadrate printable sheet is juxtaposed substantially entirely over the quadrate carrier sheet. The quadrate printable sheet is provided with a plurality of cut lines running substantially parallel to the first and second longitudinally extending sides of the quadrate carrier sheet to form a series of removable strips over each of the first and second adhesive areas.

A plurality of transversely extending cut lines extends substantially parallel to the first and second edges of the quadrate carrier sheet. Specifically, a first set of cut lines define a first peel zone along the first boundary of the first adhesive area and a second set of transversely extending cut lines define a second peel zone along the first boundary of the second adhesive area.

In a further exemplary embodiment of the presently described subject matter, a pressure sensitive laminate assembly for use in securing medical appliances is described and includes a first sheet that has top and bottom faces, first and second ends and first and second sides. A release coating is applied over the top face of the first sheet and a pattern of pressure sensitive adhesive is applied over the release coating on the top face of the first sheet. The adhesive pattern defines at least two adhesive free areas separated by regions of adhesive.

Continuing with a description of the presently described embodiment, a second sheet is applied over the pattern of pressure sensitive adhesive. The second sheet is provided with a plurality of longitudinally extending cuts and a series of transversely extending cuts running substantially perpendicular to the longitudinally extending cuts. The plurality of longitudinally extending cuts defines a series of first and second removable strips having at least first and second dimensions. The first strip has a first width and length and the second strip has a second width less than the first width and a length.

The series of transversely extending cuts defines first and second peel zones which overlie and are generally aligned with the adhesive free areas, with the first adhesive free area defining a leading edge of a first area of strips and the second adhesive free area defining a leading edge of a second area of strips. The first and second areas of strips are substantially equal in area.

In another exemplary embodiment, a healthcare form assembly includes a carrier sheet including a leading edge and a trailing edge that are opposite one another, a release coating disposed on the carrier sheet, and an adhesive layer disposed on the release coating. The healthcare form assembly also includes a printable sheet having a same or substantially the same shape as the carrier sheet and being removably disposed on the carrier sheet. The printable sheet includes a leading edge and a trailing edge that are opposite one another and oriented on the carrier sheet such that the trailing edge of the printable sheet is intimately disposed next to the trailing edge of the carrier sheet. The printable sheet defines a first set of cut lines. The printable sheet also defines another set of transversely extending cut lines extending substantially parallel to the leading edge of the printable sheet to create a first peel zone along the leading edge of the printable sheet. Optionally, the printable sheet can also define additional sets of cut lines extending substantially parallel to the leading edge of the printable sheet and spaced from the first peel zone to create additional peel zone(s). A strip or section of a layer of a deadening material is disposed in one or more of the peel zones between the release coating and the adhesive layer.

In yet another exemplary embodiment, a healthcare form assembly includes a carrier sheet including a leading edge and a trailing edge that are generally parallel to one another and a first side edge and a second side edge that are generally perpendicular to the leading edge. A distance between the leading edge and the trailing edge defines a carrier sheet length and a distance between the first side edge and the second side edge defines a carrier sheet width. Preferably, the sheet length is greater than the carrier sheet width. The healthcare form assembly also includes a release coating disposed on the carrier sheet, and an adhesive layer disposed on the release coating. The healthcare form assembly also includes a printable sheet releasably disposed on the carrier sheet. The printable sheet includes a leading edge and a trailing edge that are generally parallel to one another and a first side edge and a second side edge that are generally perpendicular to the leading edge of the printable sheet. A distance between the leading edge of the printable sheet and the trailing edge of the printable sheet defines a printable sheet length and a distance between the first side edge of the printable sheet and the second side edge of the printable sheet defines a printable sheet width. Preferably, the printable sheet length is greater than the printable sheet width. The printable sheet defines a collection of cut lines extending substantially parallel to one of the first side edge and the second side edge. This collection of cut lines defines a plurality of removable adhesive strips. The printable sheet also defines a first set of cut lines extending substantially parallel to the leading edge of the printable sheet to create a first peel zone along the leading edge of the printable sheet and a second set of cut lines extending substantially parallel to the leading edge of the printable sheet to create a second peel zone which is spaced from the first peel zone. A strip or section of a layer of a deadening material is disposed in one or more of the peel zones. Regarding the first peel zone, in an optional aspect, at least one of the strip of deadening material and/or a portion of the printable sheet extends beyond the leading edge of the carrier sheet. The second peel zone can include a bisecting cut line in the printable sheet to promote separation of removable strips on either side of the second peel zone.

In one or more of the various healthcare assemblies, a perforated or weakened release liner or liner portion is used. The perforated or weakened liner can include a plurality of release cuts formed in the liner or liner portions.

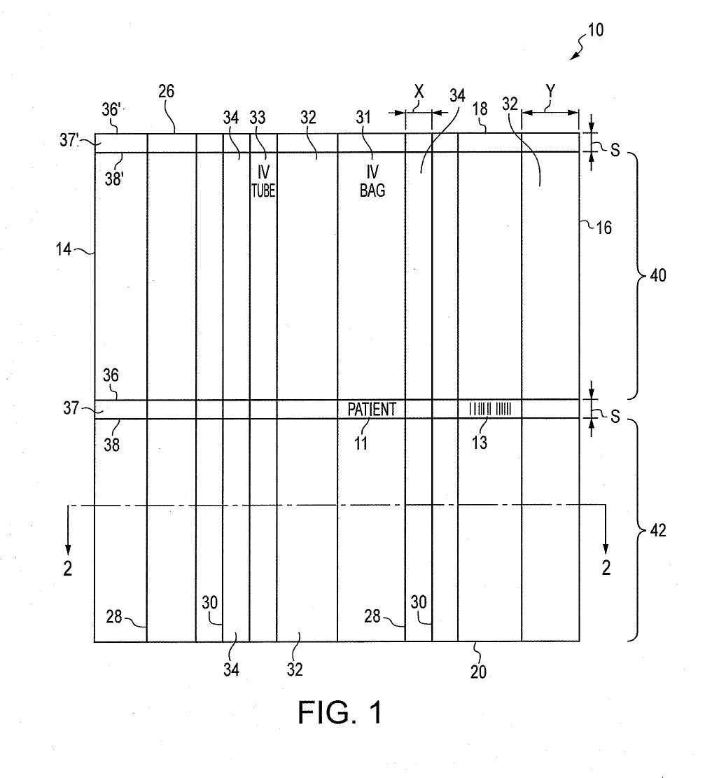

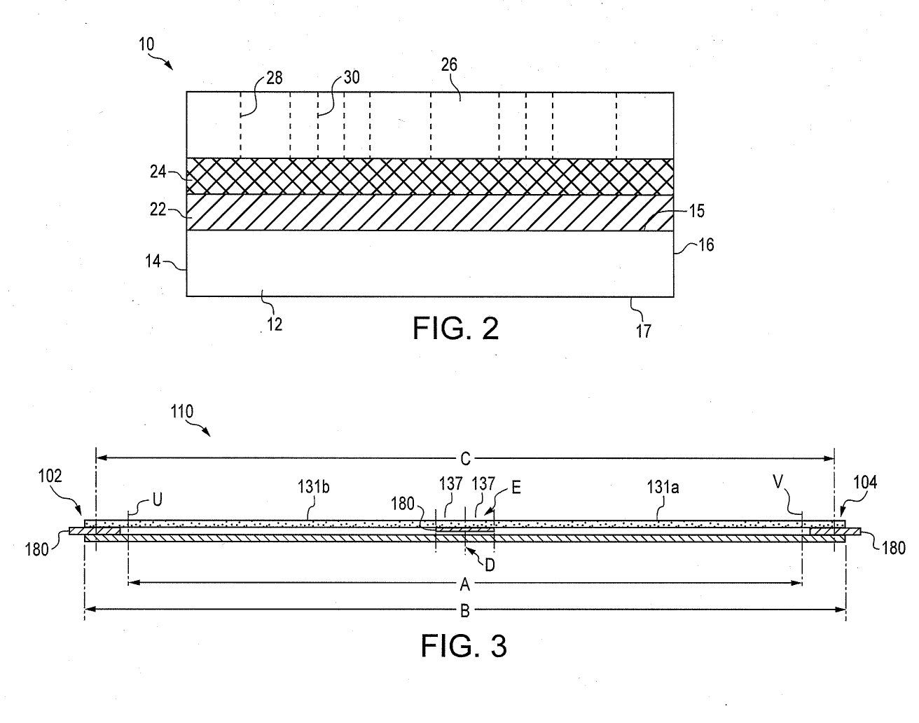

Reference is now directed to FIGS. 1 and 2 in which a preferred embodiment healthcare form assembly is generally depicted by reference to numeral 10. Periodically herein, the term “healthcare assembly” is used to refer to a “healthcare form assembly”, and so these terms are used interchangeably herein. The preferred embodiment healthcare form assembly 10 includes a quadrate carrier sheet 12 (see FIG. 2) that has first and second longitudinally extending sides 14, 16 and first and second transversely extending end edges 18, 20. The quadrate carrier sheet 12 has top and bottom face surfaces 15, 17, see FIG. 2. A release coating 22 is applied over the top face surface 15 of the quadrate sheet 12. The release coating 22 is preferably a silicone based coating. A pattern of pressure sensitive adhesive 24 is applied over the release coating 22. Preferably, the adhesive is deposited as a layer and defines at least two adhesive areas such as adhesive areas 40 and 42, which are spaced apart from one another. However, the adhesive layer may be a relatively continuous layer. Additional details concerning the adhesive layer and particularly the adhesive areas 40, 42 are provided herein. A quadrate printable sheet 26 is applied over the adhesive 24.

The printable sheet 26 is provided with a plurality of longitudinally extending cut lines such as 28, 30 which run parallel to the first and second longitudinally extending sides 14 and 16. The cut lines 28, 30 section or divide the sheet 26 into individual removable strips such as strips 32, 34, which release from the assembly with adhesive on the back side of the strips. The strips have a length and a width, with the length of the strips 32, 34 being substantially equal and the width of at least some of the strips being different. For example, the length of the strips 32, 34 may be about 133 mm (about 5.25 inches) in length and the width of strip 32 is about 25 mm (about 1.0 inch), while the width of the strip 34 is about 13 mm (about 0.5 inches). It will be appreciated however that the subject matter is not limited to these particular dimensions. For example, the length of the strips may be from about 300 mm (about 12 inches) or longer to about 25 mm (about 1 inch) or less, and typically from about 200 mm (about 8 inches) to about 50 mm (about 2 inches) in length. Furthermore, a relatively wide strip may have a width of from about 100 mm (about 4 inches) or more to about 13 mm (about 0.5 inch) or less, and typically from about 50 mm (about 2 inches) to about 20 mm (about 0.75 inch) in width. This width dimension is illustrated in FIG. 1 as dimension Y. A relatively thin strip may have a width of from about 75 mm (about 3 inches) or more to about 2.5 mm (about 0.1 inch) or less, and typically from about 25 mm (about 1 inch) to about 6 mm (about 0.25 inch) in width. This width dimension is illustrated in FIG. 1 as dimension X. Furthermore, the subject matter includes healthcare sheet assemblies having a plurality of removable adhesive strips all having the same width. In addition, it is also contemplated that the subject matter includes healthcare sheet assemblies having a plurality of removable adhesive strips which have the same width yet which differ in length. And, the subject matter includes healthcare sheet assemblies having a plurality of removable adhesive strips which have different widths and different lengths.

The printable or top sheet 26 is also provided with a plurality of transversely extending cut lines 36, 38 and 36′, 38′ (see FIG. 1) which run perpendicular to the first and second longitudinally extending sides 14, 16 and parallel to the first and second ends 18, 20. The transversely extending cut lines 36, 38 are generally located along one or both of the first and second adhesive areas 40, 42. The transversely extending cut lines 36′, 38′ are generally located along a peripheral edge, such as first end 18. The space or distance between the transversely extending cut lines 36, 38 and 36′, 38′ is illustrated in FIG. 1 as distance S. Distance S typically ranges from about 25 mm (about 1 inch) or more to about 2.5 mm (about 0.1 inch) or less and is preferably about 6 mm (about 0.25 inches). The distance S between the transversely extending cut lines 36, 38 and 36′, 38′ creates peel zones 37, 37′ which facilitate the removal of the strips 32, 34 from the assembly 10.

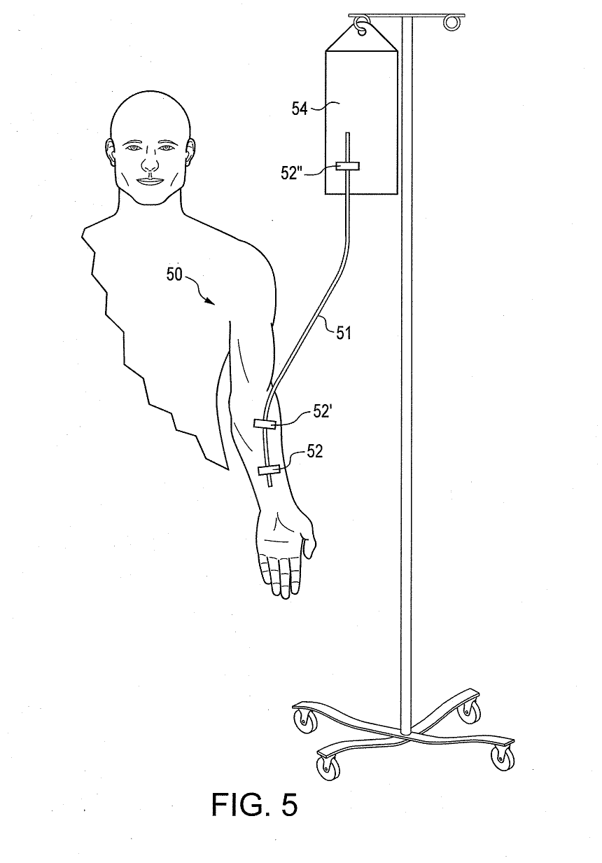

The printable sheet 26 may be provided with indicia on one or more strips such as strips 33, 31 to assist the care provider in selecting the appropriate strips for use in treating the patient. For example, strip 31 may be used to attach a tube (see FIG. 5) to an IV bag whereas strip 33 may be used to attach an IV tube to a patient's arm. Other information can be provided on the printable sheet 26, such as patient indicia and bar codes 11 and 13 respectively, or other hospital information.

The peel zones 37, 37′ of the preferred embodiment assembly 10, are preferably areas that are free of adhesive. That is, during the pattern coating of the adhesive 24, no adhesive is provided in the areas of the peel zones, thereby creating an adhesive free area. Preferably, as noted, the layer of pressure sensitive adhesive 24 is deposited so as to form a first adhesive area 40 and a second adhesive area 42, which are most preferably equal in surface area. In the embodiment illustrated in FIG. 1, the adhesive free area is preferably about 6 mm (about 0.25 inches) wide (distance S) by about 216 mm (about 8.5 inches) long. However, it will be appreciated that the subject matter includes health care form assemblies with zones having a wide range of dimensions and corresponding areas. In another embodiment, the peel zones have a width of from about 5 mm (about 0.2 inch) to about 15 mm (about 0.6 inch), and preferably from about 10 mm (0.40 inch) to about 12 mm (about 0.48 inch). It is also contemplated that the peel zones can be configured such that they are unequal in dimensions or area. For example, the peel zone 37 may have a width of about 10 mm and the peel zone 37′ may have a width of about 12 mm. Again, it will be appreciated that in no way is the subject matter limited to any of these particular dimensions. Alternatively, if adhesive is provided within a peel zone, it is deadened, such as by corona treating so that the adhesive does not create any tension when removing the strips, such as strips 32, 34 for example. In the embodiment under discussion, the first peel zone 37′ receives the leading edge of strips defined in the first adhesive area 40 while the second peel zone 37 receives the leading edge of strips defined in the second adhesive area 42. The peel zones 37 and 37′ preferably have a perforated cut through one or more edges to further promote easy separation of one or more strips from the carrier sheet of the form.

Referring again to FIG. 1, each of the first and second adhesive areas 40 and 42 preferably have an equal number of strips 32, 34 which are similarly dimensioned. That is, preferably, the number of strips extending within each of the adhesive areas 40, 42 is the same. For example in the embodiment under discussion, the strips all have a length of about 133 mm (about 5.25 inches) and widths of about 13 mm (about 0.50 inch) and 26 mm (about 1.00 inch). As noted, it will be appreciated that the subject matter is not limited to any particular size or dimensions. And so, the various strips may be provided in nearly any size, shape, configuration, or area.

In another preferred embodiment as shown in FIG. 3, a healthcare form assembly 110 is provided with a plurality of removable strips. In this embodiment, the assembly 110 includes three peel zones. Two peel zones are disposed along two peripheral or edge regions of the assembly. Another centrally located peel zone is provided between the two peripheral peel zones. In order to further promote separation of a strip from the carrier sheet at a peel zone, a strip or section of material 180 generally referred to herein as a deadening material is disposed within one or more peel zones of interest. These and other aspects are all described in greater detail herein.

In certain applications, it may be preferable to provide a centrally disposed peel zone and preferably one including a layer of deadening material within the peel zone. A centrally disposed peel zone provides another region at which one or more removable strips can be removed from the carrier. Specifically, in the preferred embodiment 110 depicted in FIG. 3, the length of the healthcare form assembly is illustrated as C which is about 320 mm (about 12.6 inches) with a central peel zone illustrated as E which is about 25 mm (about 1 inch), which is separated into two portions 137 of about 12 mm (0.5 inch) each. In this way, two strips extending across the length of the form and separated by the central peel zone E can be removed in an opposite direction from one another. Thus by bending the form about its midsection, the deadening material 180 in central peel zone E can be easily exposed to enable removal of the strips from the form. Preferably, a perforation or cut shown as D in FIG. 3 is provided to assist in separating two strips 131a and 131b from each other at the middle of the central peel zone area. FIG. 3 also illustrates dimension A which is the distance between a pair of perforations or cut lines shown as U and V which provide for tear off peel tabs. Dimension B is the length of the form assembly 110 prior to trimming edge regions 102 and 104, to produce the form having length C.

In forming the preferred embodiment healthcare sheet assemblies, and particularly those having one or more peel zones located along a peripheral edge, it may be preferred to perform a trimming operation along the peripheral edge to obtain a “clean” edge in which the edges of the carrier sheet and the printable sheet overlie one another and are generally aligned. Trimming one or more peripheral edges may also be preferred for peripheral peel zones that include a strip of deadening material. Again, in certain embodiments it may be preferred to provide a clean peripheral edge.

However, the present subject matter also includes embodiments in which a peripheral peel zone includes one or more layers that extend outward or beyond the edge of the underlying carrier sheet. Such outwardly extending regions are referred to herein as fingerlifts and promote grasping of a removable strip and separation of the strip from the carrier. Details as to the fingerlifts are described in conjunction with other preferred embodiment healthcare sheet assemblies.

Regarding the fingerlifts, in certain embodiments one or more strips or sections of deadening material can be provided partially or entirely within a peel zone, in less than all peel zones, or in all peel zones. As noted, the incorporation of deadening material may further promote ease of separation and removal of an adhesive strip from a healthcare sheet assembly. The deadening material strips can be provided in a wide array of shapes and sizes. For example, referring further to FIG. 3, the length of the deadening material strip is about 10 mm (about 0.40 inch), and the removable strip such as strip either strip 131a or 131b, has a length dimension of about 160 mm (about 6.3 inches) and a final tape length of 148 mm (160 mm with the 12 mm finger lift strip removed). The strip and the deadening material have a width of about 24 mm (about 0.95 inch).

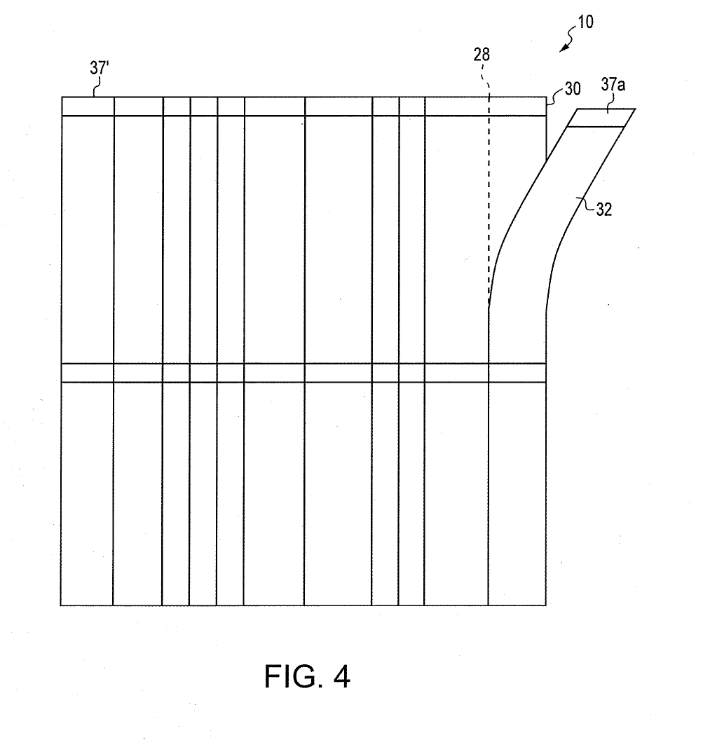

FIG. 4 illustrates the previously described healthcare assembly 10 and peeling away of one removable strip 32 through use of a peel tab 37a. The peel tab 37a is the region of the strip 32 which overlies the peel zone 37′. Preferably, the peel zone 37′ is free of adhesive or if adhesive is disposed within the peel zone 37′, the adhesive within that region is deadened. The peel tab can be readily separated from the remainder of the peel zone 37′ as a result of the longitudinally extending cut lines 28, 30 which define the individual strips.

Reference is now directed to FIG. 5 which shows an exemplary method of using the presently described subject matter. FIG. 5 provides a partial view of a patient's arm 50 to which an intravenous feed tube 51 has been connected. Removable strips 52, 52′ have been applied to the arm 50 to secure the tube 51 to the patient. In this example, the strips 52 and 52′ may be provided with removable or repositionable adhesive so that the strips may be readily removed from the patient at the end of the treatment or when changing IV bags. Strip 52″ secures the tube 51 to an IV bag 54, which may be for example accomplished through the use of a permanent adhesive so that the tube 51 does not separate from the bag 54.

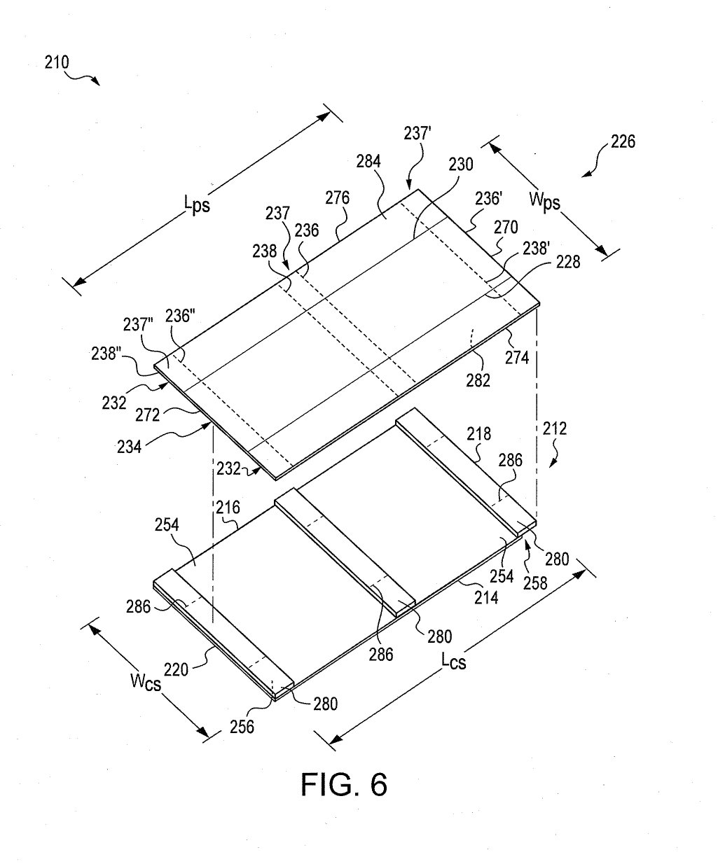

With reference to FIGS. 6 to 8, another preferred embodiment healthcare form assembly 210 is illustrated which includes a carrier sheet 212 and a printable sheet 226. The healthcare assembly 210 generally corresponds to the previously described healthcare assembly 10 illustrated in FIGS. 1 and 2, but includes three (3) peel zones and the incorporation of deadening material in each peel zone. Specifically, the healthcare assembly 210 is as follows. The carrier sheet 212 generally corresponds to the previously described quadrate sheet 12. And, the printable sheet 226 generally corresponds to the previously described printable sheet 26. The carrier sheet 212 and the printable sheet 226 can have similar shapes as will be discussed in more detail below. Further, the sizes of the carrier sheet 212 and the printable sheet 226 may be similar as will be described hereinafter.

The carrier sheet 212 defines a first face 254 that is directed toward the printable sheet 226 and a second face 256 that is directed away from the printable sheet 226. Thus, the second face 256 is oppositely directed from the first face 254. The carrier sheet 212 also includes a leading or first end edge 218 and a trailing or second end edge 220. The leading edge 218 and the trailing edge 220 are opposite one another and can be generally parallel to one another. The distance between the leading edge 218 and the trailing edge 220 defines the carrier sheet length L_{cs}.

With continued reference to FIG. 6, the carrier sheet 212 also includes a first side edge or first longitudinally extending side 214 and a second side edge or second longitudinally extending side 216. The first side edge 214 and the second side edge 216 can be generally parallel to one another and also generally perpendicular to the leading edge 218 and the trailing edge 220. The distance between the first side edge 214 and the second side edge 216 defines the carrier sheet width W_{cs}. The carrier sheet length L_{cs} is preferably greater than the carrier sheet width W_{cs}.

Further, the leading edge 218 of the carrier sheet 212, the trailing edge 220 of the carrier sheet 212, the first side edge 214 of the carrier sheet 212 and the second side edge 216 of the carrier sheet 212 cooperate to define a perimeter P_{cs} of the carrier sheet 212. The aforementioned shape of the carrier sheet 212 is beneficial for a number of reasons. For example, the rectangular shape of the carrier sheet 212 minimizes the amount of waste that is created during the manufacturing process since multiple carrier sheets can be cut from a larger master carrier sheet and minimal scrap pieces are created. Additionally, packaging of the healthcare form assembly 210 is simplified due to the fact that existing containers can be utilized to ship the assembly 210, thereby eliminating the need for a new container to be designed and manufactured.

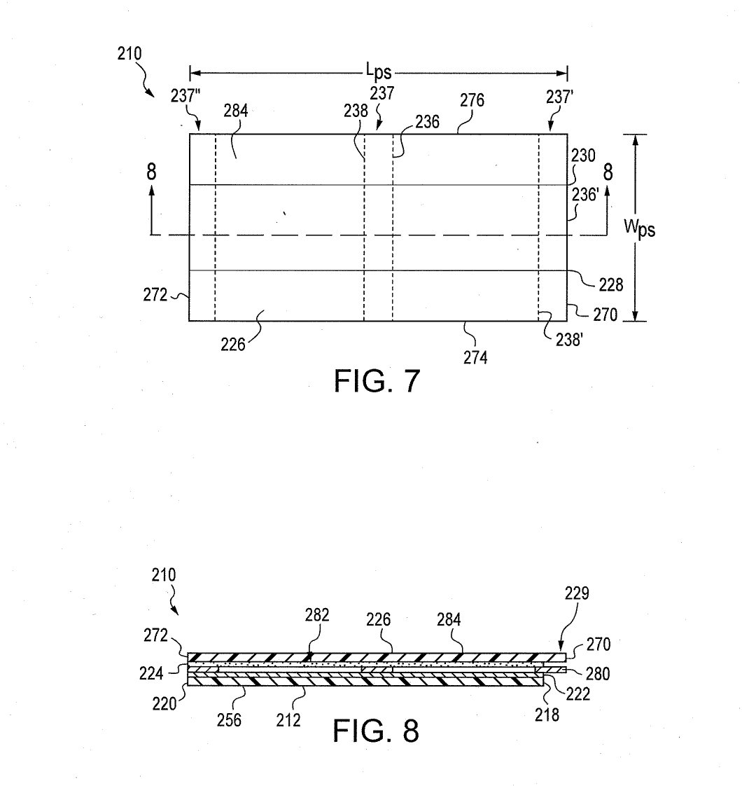

FIG. 7 is a top planar view of the healthcare assembly 210 of FIG. 6. FIG. 8 is a cross sectional view of the assembly 210 taken across line 8-8 in FIG. 7. As shown in FIG. 8, a release coating 222 is applied to the first face 254 of the carrier sheet 212. The release coating 222 can be of any number of formulations described in greater detail herein. The release coating 222 may be applied to the carrier sheet 212 in a solid or liquid format. The release coating 222 typically covers most or all of the first face 254 of the carrier sheet 212.

With continued reference to FIG. 8, an adhesive layer 224 is disposed adjacent to the release coating 222 of the carrier sheet 212. The adhesive layer 224 can be applied to a face or portion of the printable sheet 226, and specifically to the face of the printable sheet 226 directed toward the carrier sheet 212. The adhesive layer 224 may be applied in a pattern and may be of a reusable or permanent type adhesive. Alternatively, the adhesive layer 224 can be applied to the release coating 222 in a solid or liquid format.

With reference once again to FIG. 6, the printable sheet 226 can have a rectangular shape. However, the subject matter includes a wide array of other shapes. Further, the printable sheet 226 can be a same shape as the carrier sheet 212. As illustrated, the printable sheet 226 is removably and releasably disposed on the carrier sheet 212. The printable sheet 226 includes a leading edge 270 and a trailing edge 272 that are opposite one another and generally parallel to one another. The distance between the leading edge 270 and the trailing edge 272 defines the printable sheet length Lₚₛ.

As shown in FIG. 7, the printable sheet 226 also includes a first side edge 274 and a second side edge 276. The first side edge 274 and the second side edge 276 can be generally parallel to one another and generally perpendicular to the leading edge 270 and the trailing edge 272. The distance between the first side edge 274 and the second side edge 276 defines the printable sheet width Wₚₛ. The printable sheet length Lₚₛ is preferably greater than the printable sheet width Wₚₛ.

The trailing edge 272 of the printable sheet 226, the first side edge 274 of the printable sheet 226, the leading edge 270 of the printable sheet 226, and the second side edge 276 of the printable sheet 226 cooperate to define a perimeter Pₚₛ of the printable sheet 226. Preferably, for rectangular or square shaped printable sheets 226, a summation of two times the length Lₚₛ and two times the width Wₚₛ equals a perimeter Pₚₛ of the printable sheet 226. Further for rectangular or square shaped printable sheets 226, an area Aₚₛ of the printable sheet 226 is defined by the product of the length Lₚₛ and the width Wₚₛ.

With further reference to FIGS. 6-8, the printable sheet 226 also includes an inner face 282 and an outer face 284. The inner face 282 is directed toward the first face 254 of the carrier sheet 212 and the outer face 284 is oppositely directed from the inner face 282 and faces away from the carrier sheet 212. The outer face 284 can include indicia such as for example indicia 11, 13 as shown in FIG. 1.

With continued reference to FIG. 6, the printable sheet 226 also defines a first set of cut lines 236, 238. The first set of cut lines 236, 238 extend substantially parallel to the leading edge 270 of the printable sheet 226 to create a first peel zone 237. Preferably, the peel zone 237 is defined generally proximate the midsection of the printable sheet 226 and most preferably oriented to extend collinearly with a line bisecting the printable sheet 226 into two halves of equal area. The printable sheet 226 also defines a second set of cut lines 236′, 238′ that extend substantially parallel to and alongside the leading edge 270 of the printable sheet 226 to create a second peel zone 237′. And, the printable sheet 226 also defines a third set of cut lines 236″, 238″ that extend substantially parallel to and alongside the trailing edge 272 of the printable sheet 226 to create a third peel zone 237″.

The printable sheet 226 also defines at least one longitudinal cut line 228, 230 that extends between the leading edge 270 of the printable sheet 226 and the trailing edge 272 of the printable sheet 226 so as to create a plurality of strips 232, 234. The longitudinal cut lines 228, 230 are generally parallel to the first side edge 274 and are spaced from the first side edge 274 of the printable sheet 226 such that the strips 232, 234 are of unequal width. However, it will be appreciated that the cut lines 228, 230 could be located along the printable sheet 226 so as to define strips of equal width. As described hereinbefore, these strips 232, 234 can be used to affix various medical products to patients or to other medical components.

With further reference to FIGS. 6 and 8, the healthcare form assembly 210 preferably includes deadening material 280 disposed between the carrier sheet 212 and the printable sheet 226 and specifically, between the adhesive layer 224 and the release coating 222, as shown in FIG. 8. The deadening material 280 is preferably disposed in the peel zones 237, 237′, and 237″. The deadening material 280 extends between the first side 214 and the second side 216 of the carrier sheet 212. The deadening material 280 can be rectangular in shape and prevents at least a portion of the adhesive layer 224 from adhering to select regions of the carrier sheet 212, and specifically, the release coating 222 disposed on the carrier sheet 212. Furthermore, regions of the adhesive layer 224 in contact with the deadening material 280 also serve to adhere or retain the deadening material to the printable sheet 226 and specifically to the inner face 282 of the printable sheet 226. FIG. 8 illustrates provision of fingerlifts 229 which comprise regions of both the printable sheet 226 and the deadening material 280 extending beyond the leading edge 218 of the carrier sheet 212.

Preferably, strips of deadening material 280 are disposed within each of the peel zones. However, the subject matter includes providing one or more peel zones free of deadening material. The peel zones which are free of deadening material can utilize other provisions for promoting separation of a region of the printable sheet 226 from the carrier sheet 212 such as making such area free of adhesive or deadening any adhesive in the particular peel zone as previously noted in conjunction with the description of the healthcare assembly 10. Furthermore, it is also contemplated that for a peel zone including a strip or section of a deadening material, that the deadening material need not cover or extend within the entire peel zone.

Referring again to FIG. 6, the deadening material 280 preferably defines at least one longitudinal cut line 286 that extends in a direction generally parallel to the first side edge 214 of the carrier sheet 212. Further, the at least one longitudinal cut line 286 of the deadening material 280 and the at least one longitudinal cut line 228, 230 of the printable sheet 226 are substantially aligned and coplanar in a plane generally perpendicular to the first face 254 of the carrier sheet 212. Since the at least one longitudinal cut line 286 of the deadening material 280 and the at least one longitudinal cut line 228, 230 of the printable sheet 226 are substantially aligned and coplanar, strips from the printable sheet 226 can more easily be removed from the carrier sheet 212. This results in a healthcare form assembly 210 that can be quickly and efficiently used on a patient as will be described in more detail hereinafter.

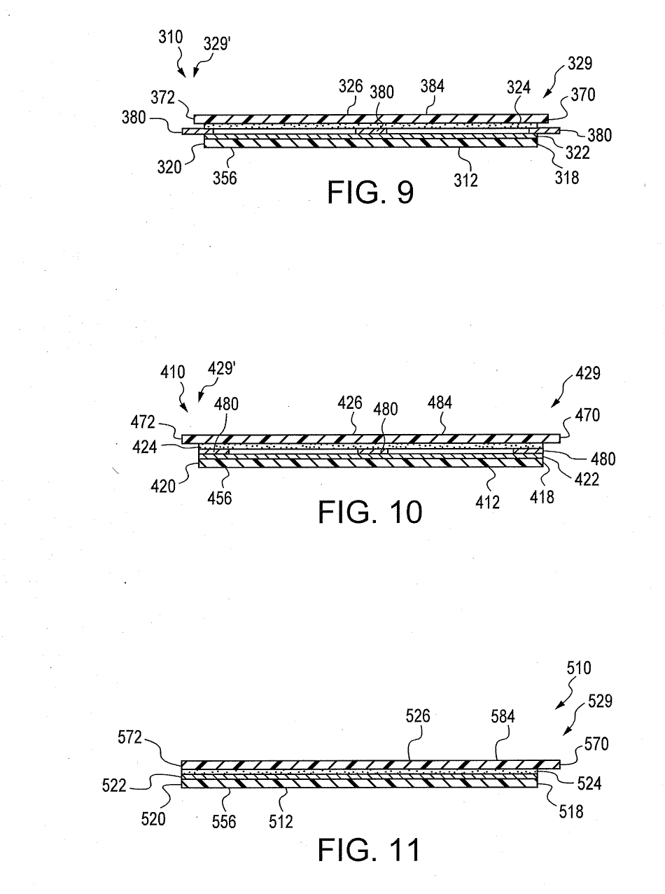

The present subject matter includes a wide array of peel zones, fingerlifts, and configurations for promoting separation of a removable adhesive strip from a carrier sheet in a healthcare assembly. As shown in FIG. 9, in certain embodiments at least a portion of the deadening material and the printable sheet extend beyond the leading edge of the carrier sheet, however their outer edges need not be aligned as in the embodiment depicted in FIG. 8. Specifically, FIG. 9 illustrates an alternate preferred embodiment healthcare assembly 310 having portions of deadening material 380 extending laterally outward beyond an edge 318 of a carrier sheet 312. Specifically, a fingerlift 329 is formed adjacent the edge 318 of the carrier sheet 312 by the regions of outwardly extending deadening material 380 and a portion of a printable sheet 326 which extend beyond the edge 318 of the carrier sheet 312. In this embodiment 310, a similar fingerlift 329′ is provided adjacent an opposite edge 320 of the carrier sheet 312.

The subject matter also includes versions of the healthcare assembly in which both regions of the printable sheet and regions of deadening material extend beyond an outer edge of a carrier sheet, and further in which the region of outwardly extending printable sheet extends beyond an outer edge of the deadening material. Moreover, it is contemplated that this configuration could be provided at all or in less than all peel zones defined along a peripheral edge of a healthcare assembly.

As previously described and shown in FIGS. 8 and 9, in certain embodiments at least a portion of the leading edge of the printable sheet extends beyond the leading edge of the carrier sheet. Thus, for example in FIG. 9, the leading edge 370 of the printable sheet 326 extends beyond the leading edge 318 of the carrier sheet 312. In such embodiments, typically the printable sheet length Lₚₛ is greater than the carrier sheet length L_{cs}. Furthermore, in such embodiments, the area Aₚₛ of the printable sheet is greater than the area A_{cs} of the carrier sheet and the printable sheet perimeter Pₚₛ is greater than the carrier sheet perimeter P_{cs}.

FIG. 10 is a cross sectional view of yet another preferred embodiment healthcare assembly 410 in accordance with the subject matter. In this embodiment, fingerlifts 429 and 429′ are provided by only a region of a printable sheet 426 and specifically edges 470 and 472, extending beyond edges 418 and 420 of a carrier sheet 412. Thus, in this embodiment, outer edges of a deadening material 480 are aligned with the edges 418 and 420 of the carrier sheet 412, and do not extend outward past the edges 418 and 420.

The subject matter includes embodiments in which only a single fingerlift of the configuration depicted in FIG. 10 is provided along a peripheral edge of a healthcare assembly. This embodiment may be preferred for versions of the healthcare assembly in which relatively long removable strips are provided that extend along an entire length or width of the assembly. Thus, typically only a single peel zone is needed.

Referring to FIG. 11, another preferred embodiment healthcare assembly 510 is shown having at least one fingerlift 529 along a peripheral region of the assembly 510. In this embodiment, the assembly 510 is free of strips or sections of deadening material. This embodiment may be preferred for low cost versions of the subject matter yet which include one or more fingerlifts. Referring further to FIG. 11, when a printable sheet 526 is disposed on a carrier sheet 512 and a trailing edge 572 of the printable sheet 526 is aligned with a trailing edge 520 of the carrier sheet 512, a leading edge 570 of the printable sheet 526 is spaced from the trailing edge 520 of the carrier sheet 512 a distance that is greater than a distance between the leading edge 518 of the carrier sheet 512 and the trailing edge 520 of the carrier sheet 512. More particularly, when the trailing edge 572 of the printable sheet 526 is aligned with the trailing edge 520 of the carrier sheet 512, the respective trailing edges 572, 520 are substantially coplanar in a plane generally perpendicular to a face 556 of the carrier sheet 512.

In certain embodiments as shown in FIGS. 9 and 10, the leading and trailing edges of the printable sheet extend beyond the leading and trailing edges of the carrier sheet. Thus in FIG. 9 for example, the leading and trailing edges 370, 372 of the printable sheet 326 extend beyond the leading and trailing edges 318, 320 of the carrier sheet 312. Further, as illustrated in FIG. 9, the deadening material 380 extends beyond the leading and trailing edges 318, 320 of the carrier sheet 312. With the configuration illustrated in these figures, the strips can be easily and quickly removed from either end of the carrier sheet.

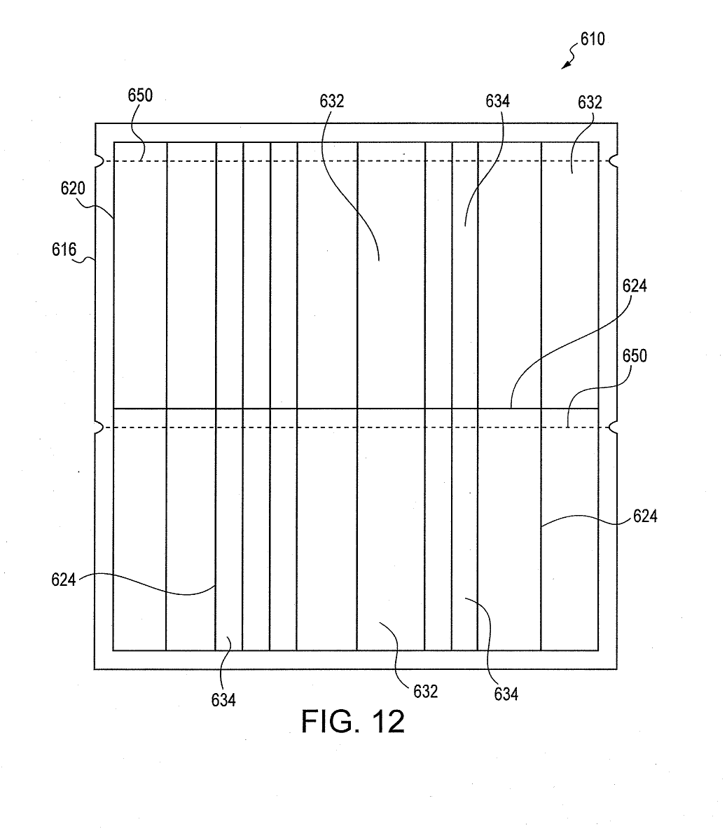

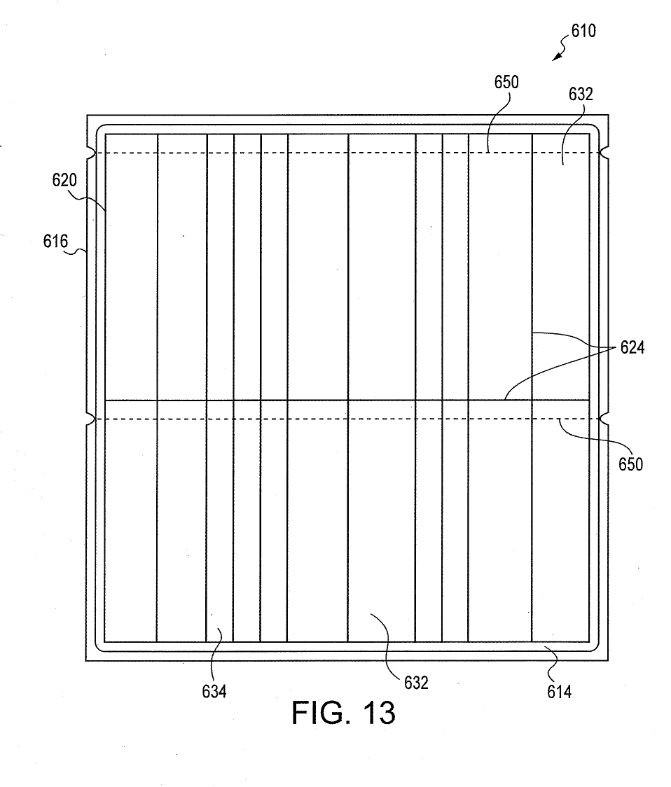

FIG. 12 shows another embodiment of a healthcare form assembly 610 in which the strips can be easily removed. The healthcare assembly 610 is preferably of an overall standard size such as 8.5 inches by 11 inches, or A4 (approximately 21 cm by 29.7 cm), or 4 inches by 6 inches, or other size compatible with standard printers used with personal computers. Assembly 610 includes a carrier sheet or release liner sheet or simply release liner 616 with a printable sheet of facestock material 620 releasably adhered thereto via a pressure sensitive adhesive. The release liner 616 is coated with a thin layer of release material such as silicone, or is otherwise constructed or treated such that the strips can be easily removed therefrom. The sheet of facestock material comprises a generally rectangular sheet of paper or film facestock cut or otherwise provided with a plurality of removable adhesive strips 632, 634 formed therein such as by die cutting. Die cut lines or severing lines which form strips are generally shown as lines 624. In many of the embodiments described herein, the terms “release liner” or “liner” are used interchangeably with the previously described term “carrier sheet”. It will be understood that these terms as used herein are synonymous with each other. Similarly, the terms “facestock layer” or “facestock” are used interchangeably with the previously described term “printable sheet.” These terms as used herein are synonymous with each other. Optionally, a section of the facestock sheet not used for adhesive strips 632, 634 constitutes a border or matrix 614 as shown in FIG. 13. In FIGS. 12-13 the facestock sheet 620 is shown smaller than the release liner 616, although it is not necessary that the facestock sheet be smaller than the release liner. Additionally, although the healthcare assembly 610 is shown with a matrix 614 in FIG. 13, it is not necessary for the subject matter that the healthcare assembly 610 includes a matrix 614 surrounding and/or between strips 632, 634. Previously described FIG. 12 depicts the healthcare assembly 610 without the matrix 614. The liner 616 defines one or more weakened separation lines 650 generally extending across at least a majority of the facestock 620. The separation line(s) are described in greater detail herein.

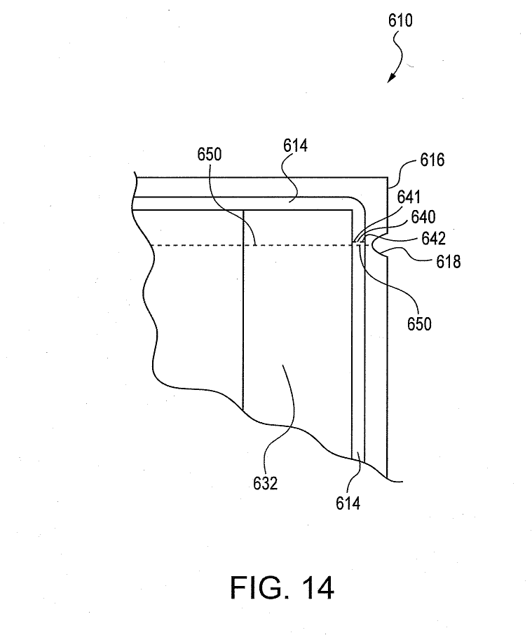

FIG. 14 is a detailed view of the upper right hand corner of the healthcare assembly 610 of FIG. 13. The matrix 614 has a weakened separation line 640 formed therein near one edge of the row of strips 632, 634. Matrix separation line 640 includes a plurality of cuts 641 and a plurality of small ties 642. Cuts and ties are described in greater detail herein. The weakened separation line 650 formed in the liner 616 extends generally from one edge of the assembly 610 to an opposite edge of the assembly 610 and runs preferably linearly beneath strips 632, 634 along a column or row of strips, and near an edge of the strips. Preferably liner separation line 650 extends less than one centimeter from the edge of the strips, and more preferably approximately 0.6 centimeters (approximately 0.25 inch) from the edge of the strips. Liner separation line 650 is shown running horizontally underneath a row of strips; however, the assembly 610 can alternatively be constructed such that the separation lines run vertically beneath a column of strips. Liner 616 also optionally includes a notch 618 generally in alignment with the liner separation line 650 and the cuts and ties 641, 642 respectively, in matrix 614. As shown in FIGS. 12 and 13, a similar structure of weakened separation lines and notches is created at the top left hand corner of the assembly 610. Additionally, assembly 610 includes one or more other sets of weakened separation lines and notches, one set for each column of strips with the weakened separation lines running underneath the column of strips at approximately 0.6 centimeters from one edge thereof. If the assembly 610 had been laid out to include a different number of rows of strips, e.g. three rows, four rows, five rows, etc., the assembly would include a corresponding number of sets of separation lines and notches. Arrows (not shown) may optionally be printed on the facestock material to instruct or encourage the user to begin tearing the assembly at notches 618. Alternatively, other instructional indicia or written instructions, such as the words “Tear Here” or the like, could be printed on the assembly.

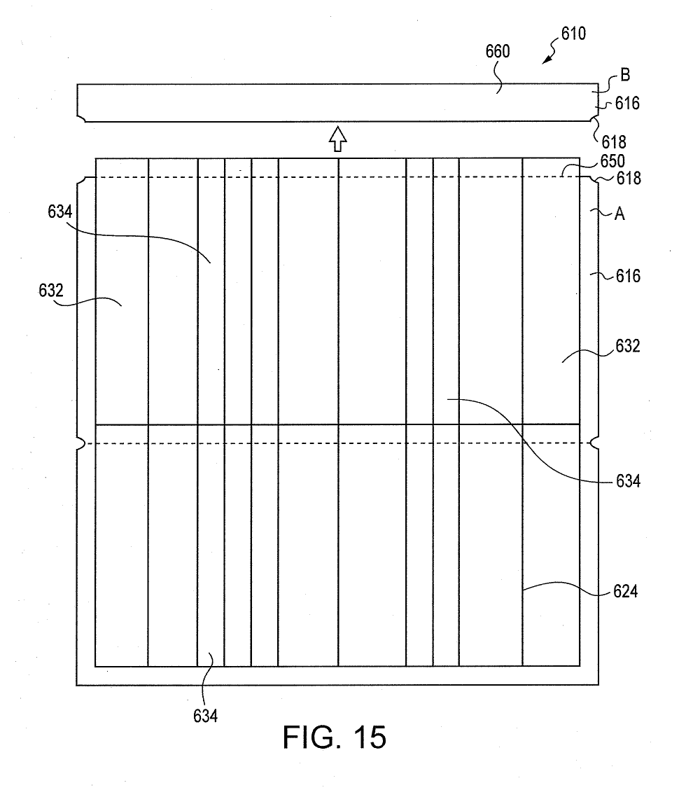

Referring further to FIG. 14, the distance between liner separation line 650 and the cuts and ties 641, 642 in the matrix 614 which form matrix separation line 640 is exaggerated in the figures for illustration purposes. The separation lines in the liner and in the matrix are preferably placed close enough together such that, after assembly 610 has been printed on by a printer, a user can tear off a strip 660 of liner 616 and optional matrix as illustrated in the variant version of FIG. 15 in a single fluid motion without any further physical preparation of assembly 610 being required between the printing and the tearing steps. Referring further to FIG. 14, at the same time, the separation lines 640 and 650 are slightly separated so that the portion of the matrix 614 overlying liner separation line 650 helps to keep liner 616 from prematurely tearing, and the portion of the liner underneath matrix separation line 640 helps to keep the matrix from prematurely tearing. Another reason for offsetting the two separation lines 640, 650 relates to manufacturing. If the separation line in the facestock were to be die cut directly over the separation line in the liner, the die pressing into the facestock would have a tendency to deform the facestock material rather than cut cleanly into it because there would be insufficient liner strength to support the dies cutting into the facestock. Therefore, the two separation lines 640, 650 are preferably offset by enough distance such that normal manufacturing tolerances are unlikely to produce a cut-on-cut situation. Preferably, matrix separation line 640 is offset from the liner separation line 650 by less than 5 mm; more preferably, the two are separated by less than 2 mm; more preferably still, the two are separated by less than 1 mm. It has been found that an offset distance of approximately 0.5 mm produces good results for typical sheets of paper strips. However, the exact separation distance is not critical. Furthermore, the preferred separation distance can vary depending upon the thickness and strength of the liner and matrix, the strength of the pressure sensitive adhesive and the effectiveness of the release liner, the overall size of the assembly, and other factors.

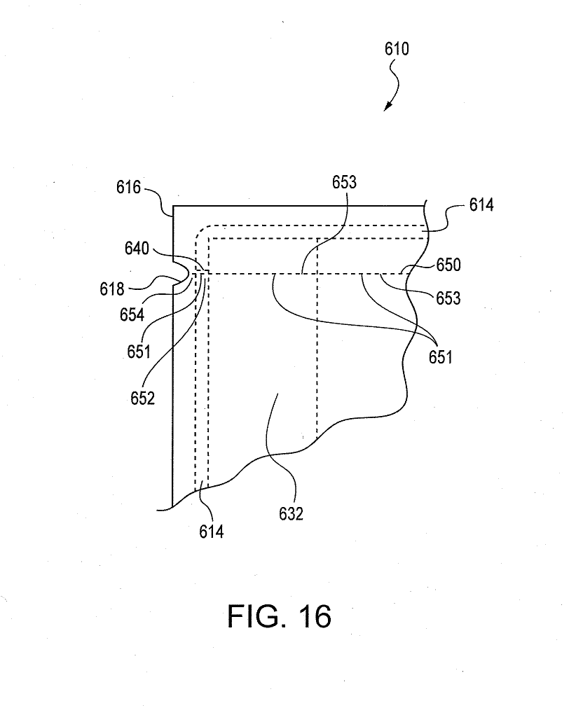

FIG. 16 shows the back side of the upper right hand corner of the healthcare assembly 610 illustrated in FIG. 14. Liner separation line 650 is illustrated in greater detail. That line includes a plurality of cuts 651, and plurality of ties 652 and 653. In the embodiment shown one small tie 652 lies underneath the matrix 614, and a plurality of small ties 653 lie underneath each strip 632, 634. As will be appreciated, ties 653 separate cuts 651. The particular locations of the ties are not critical. Additionally, release liner 616 includes a large tie 654 near the notch 618 or, if no notch is present, near the edge of the release liner 616.

Both the matrix separation line 640 and the liner separation line 650 extend parallel to the edge of a row of strips and are disposed about 0.6 centimeters from the edge of the row. The exact distance is not critical. Preferably, however, the separation lines 640 and 650 are offset from the edge of the row of strips far enough so that when a strip 632 is removed, remaining strips 632, 634 can be easily grasped and removed by the user. At the same time, the separation lines are close enough to the edge of the strips such that when strip 632 is removed a narrow enough edge of the strips is exposed so that when the healthcare sheet is placed onto a table or similar surface, the exposed edges of the unremoved strips 632, 634 do not easily and inadvertently stick to the table.

The purpose of these structures will now be described with reference to FIGS. 12-16. FIG. 15 shows a method of using the healthcare sheet assembly of FIG. 12. For purposes of this discussion, it will be assumed that the upper left hand corner of healthcare assembly 610 has a structure that is the mirror image of the structure shown in FIG. 14, with corresponding parts having the same reference designators. The user grasps one corner of the healthcare assembly 610 at approximately position A with one thumb and forefinger, and with the other thumb and forefinger grasps the narrow strip 660 of release liner 616 and optional matrix (not shown in FIG. 15) at location B so as to focus the shear forces at notch 618 and a large tie 654 (noted in FIG. 16), and begins tearing strip 660 away from the rest of the sheet. After large tie 654 is broken, the tearing away of the liner strip 660 progresses relatively easily through small ties 652 and 653 within release liner 616, and if a matrix is present through small ties 642 within matrix 614, until the strip 660 is completely torn off. This leaves the healthcare assembly 610 as shown in FIG. 15, i.e., with one row of strips 632, 634 mostly attached to the release liner 616 but having a relatively narrow region of the strips with the underlying liner portion removed. The user can then easily peel off the individual strips 632, 634 by hand one by one as desired without having to bend and manipulate the assembly 610 each time the user wishes to remove the next strip.

FIG. 17 shows another method of using the healthcare sheet assembly 610 of FIG. 12. As previously noted, the assembly 610 includes two sets of horizontal separation lines 650, one set of separation lines associated with each row of strips 632, 634. The separation lines 650 divide the assembly 610 into two individual portions 675 and 670 which may be individually separated from each other. In FIG. 17, the upper portion 675 has been separated from the lower portion 670. The strips within the lower portion 670 are now ready to be easily peeled one by one from the liner 616 and applied to skin or other substrates. Section 675 does not have any portions of the strips with their adhesive sides exposed. Thus, portion 675 can be handled and/or stored for later use without any degradation of the adhesive on the backs of those strips. Remaining portion 675 could even be fed through a printer for later printing. For example, if only eleven or fewer strips needed to be printed and used, prior to separation of portions 675 and 670, the user could run assembly 610 through the printer and print only on strips within the row of strips in section 670. The user would then separate section 670 and use the strips within that section. Remaining section 675 would be stored for later use. When additional strips are ready to be printed, the healthcare assembly could be fed through the printer.

Of course, the strips on the healthcare sheet need not be generally rectangular in shape and butting against each other as in the embodiment shown in FIGS. 12-17. The strips could be virtually any shape and could be completely separated from each other by matrix therebetween or by bare liner.

The size of the cuts and the size of the ties are chosen so that the assembly is strong enough to be fed through a printer such as a laser printer or an ink jet printer, but weak enough so that the user can tear off the release liner strip along the separation line in an easy and fluid motion without any other mechanical preparation of the healthcare sheet between the printing and the tearing steps. The ratio of cut length to overall separation line length is greater than 95% to ensure ease of separation. It has been found that an average tensile strength of the facestock and liner along the separation lines of 6 gm/cm produces good results, and it is expected that values of about 4 gm/cm to 10 gm/cm would also produce good results, and that values of about 2 gm/cm to 15 gm/cm would also be acceptable.

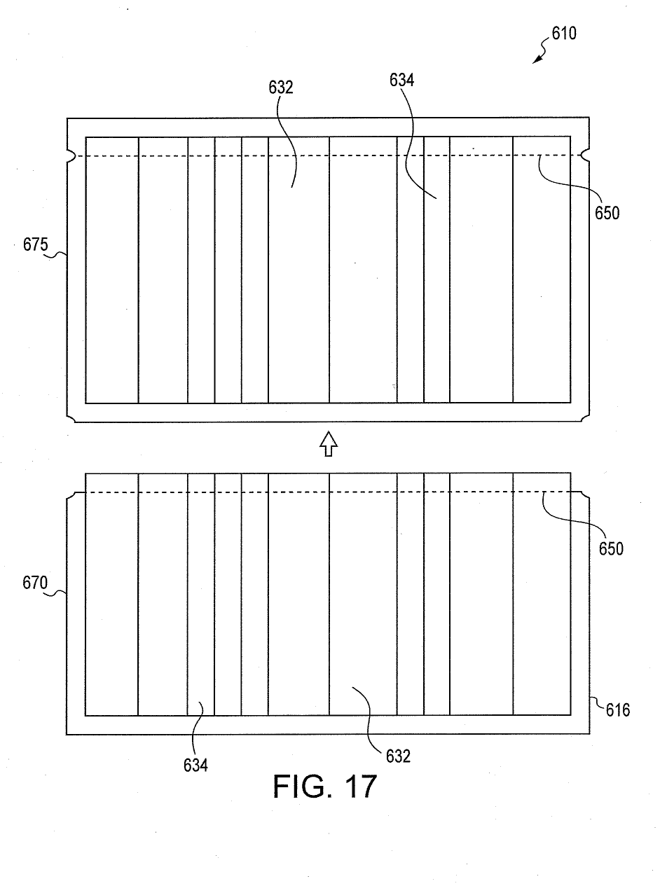

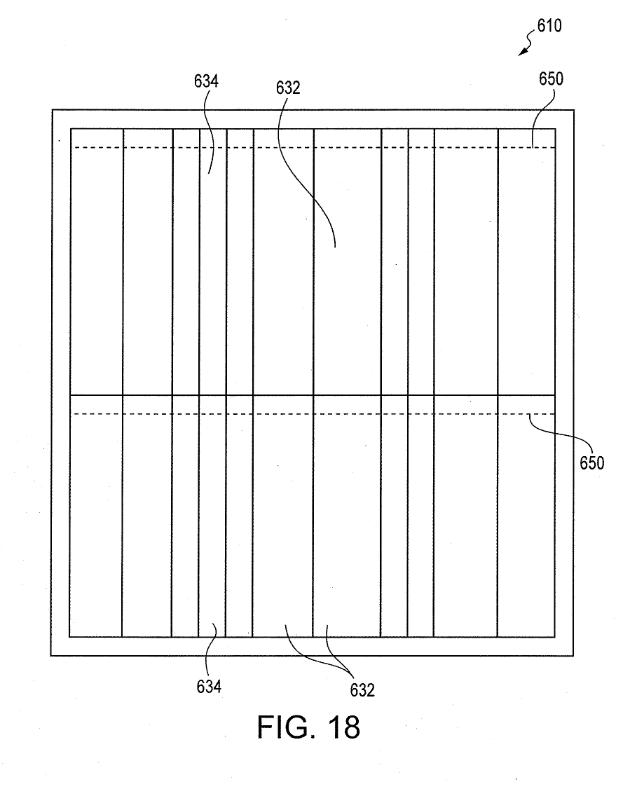

FIG. 18 shows another embodiment similar to the embodiment shown in FIG. 12, except that the healthcare assembly 610 does not include notches.

As shown in the referenced figures, the printable sheet or facestock material 620 is slightly smaller than the liner 616 such that matrix 614 does not extend to the edge of the label assembly. If the facestock were to extend to the edge of the healthcare sheet, it would be desirable to form notch 618 in both matrix 614 and liner 616.

In yet another possible embodiment, the healthcare assembly would not include a matrix bordering the strips. In FIG. 13, for example, matrix 614 could be entirely stripped from the healthcare sheet before the product is sold. Alternatively, the entire sheet of facestock material 620 could be die cut such that the entirety of the facestock material formed strips. The facestock material could either take up the same amount of facestock area as shown in FIG. 13, or a significantly smaller area. Regardless of how the facestock material were constructed, shaped, and cut, a healthcare sheet without a matrix could still employ the present subject matter so that a narrow strip of liner material could be easily removed in a fluid motion from a number of strips at a single time, thus exposing a minor portion of those strips so that they could thereafter be easily removed from the remaining portion of the liner.

Additionally, it will be understood that the present subject matter can be used with various types and media of labels and/or strips such as metallic foil, clear plastic, MYLAR®, and other well known materials. The strips could be colored or clear, and could contain pre-printed indicia such as text, two dimensional graphic or photographic images, or holographic images. The subject matter could be used with a variety of printing devices including but not limited to printers for use with a personal computer.

The present subject matter is well suited for applications in which the strips will be individually removed by hand. However, the subject matter is not limited to hand use. The subject matter could be used with automated machinery for tearing strip 660 (FIG. 15) away and thereafter placing strips 632, 634 on a substrate. The subject matter could also be used in applications in which a plurality of strips are to be positioned over one or more substrate objects and applied thereto as a group in the same relative positions on which those strips are found on healthcare assembly 610.

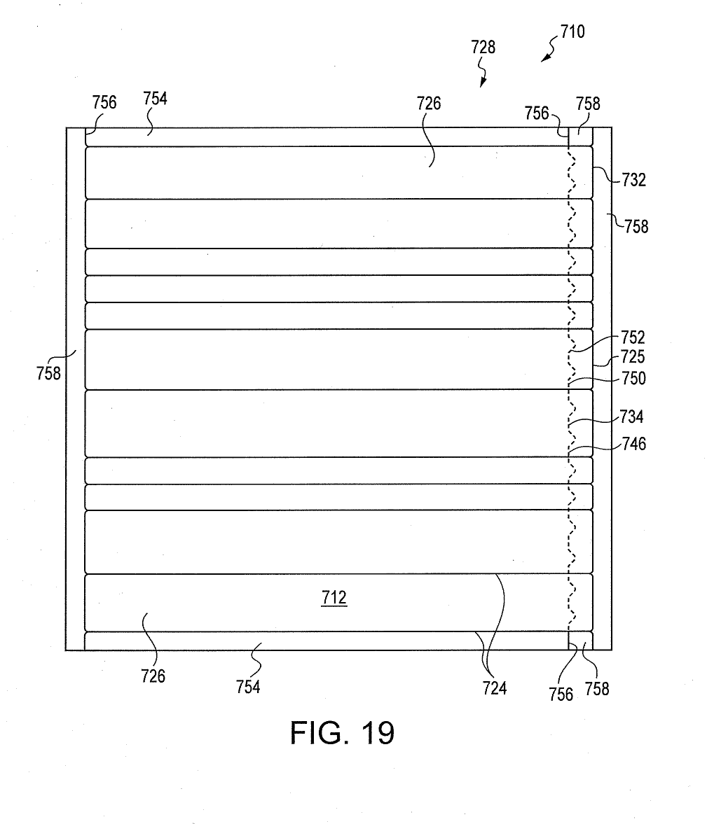

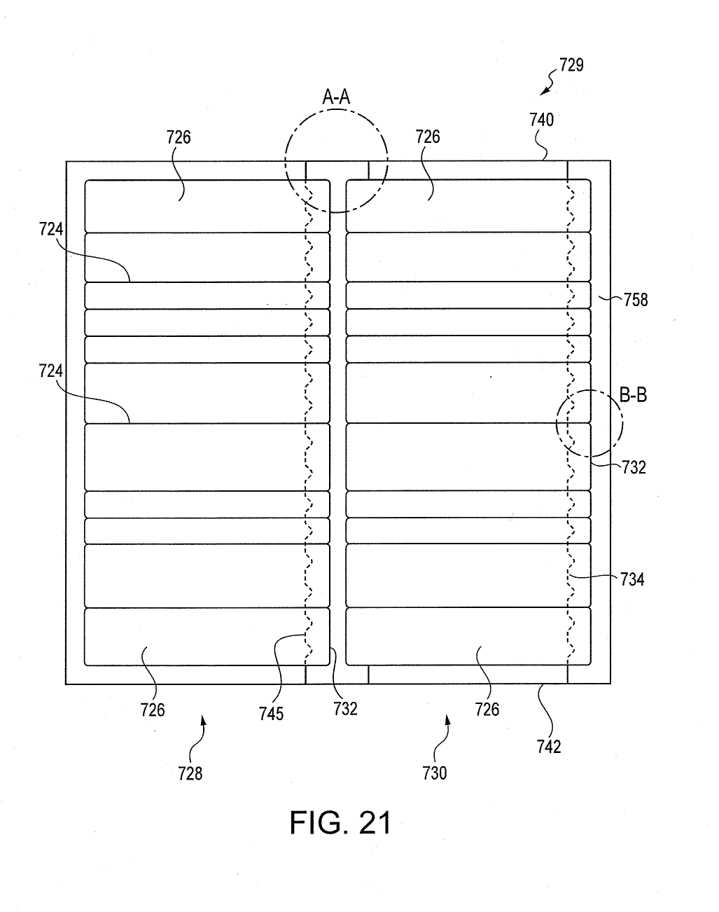

Another embodiment of the present subject matter is shown in FIG. 19. A healthcare sheet 710 illustrated in FIG. 19 includes a plurality of die cut lines or die cuts 724 in a printable facestock 712 forming strips 726. Each strip has one or more edges 725. The die cuts, i.e., continuous cuts, penetrate through the facestock but do not cut through a release-coated liner (not shown). The resulting strips form a column 728 of strips 726. The strips can abut one another, as shown in FIG. 19, or can be spaced apart. Additionally, an alternative embodiment 729 is shown in FIG. 21 that includes two columns 728, 730 formed in the healthcare sheet 729 and spaced apart from one another. Other alternative embodiments can include columns that abut one another, with no space between adjacent columns. As used herein, the word “adjacent” means nearby. Thus, embodiments of the healthcare sheets include a variety of strip arrangements including a matrix-type layout wherein adjacent strips abut one another and a spaced-apart layout where adjacent strips do not abut one another, and combinations of the two layouts wherein some adjacent strips abut one another and other adjacent strips do not abut one another. In yet another embodiment, the column of strips can be a single strip. Further, it should be understood that the die cuts forming the strips can be discontinuous cuts, for example, perforations, or cuts and ties, although discontinuous die cuts are less desirable.

Referring to FIG. 19, the column 728 of strips 726 can be further defined as including a linear edge 732. All the edges 725 of strips 726 in the column 728 abut the linear edge 732, thus aligning the strips along the linear edge. An alternative embodiment includes a column of strips in a staggered configuration so that the strips do not share a common linear edge.

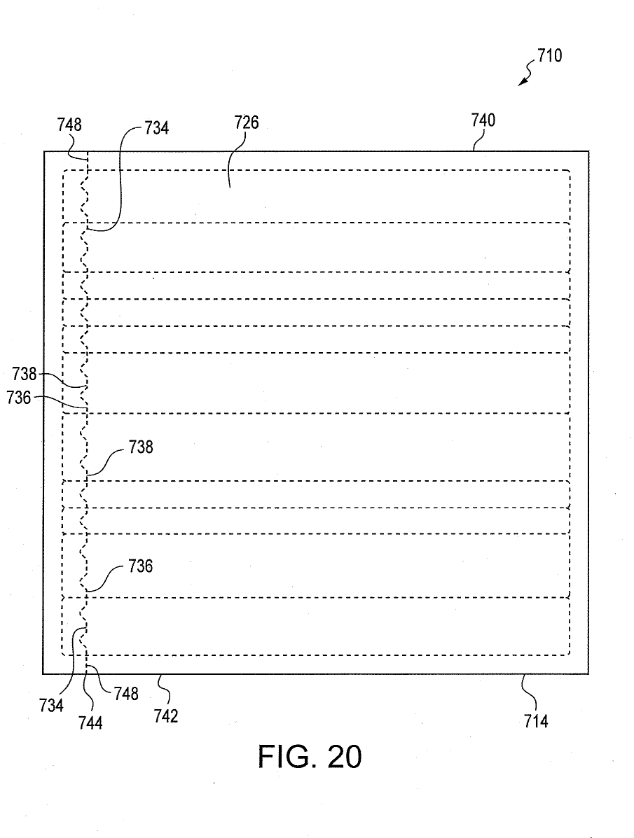

As best seen in FIG. 20, which illustrates the back surface of the healthcare sheet 710 in FIG. 19, a release-coated liner 714 has a liner weakened separation line 734 formed therein. As shown, the liner weakened separation line is made of cuts 736 and ties 738. In alternative embodiments, the liner weakened separation line 734 can be made of, for example, perforations, continuous die cuts, and scored lines. The liner weakened separation line 734 can penetrate through the release-coated liner 714, but does not penetrate through the facestock 712. The liner weakened separation line 734 extends from a first edge 740 of the healthcare sheet 710 to an opposite second edge 742 of the healthcare sheet 710. An end 744 of the liner weakened separation line 734 can terminate at an edge with either a cut or a tie but preferably terminates with a tie. As shown in FIG. 22, which illustrates the back surface of the healthcare sheet 729 in FIG. 21, an alternative embodiment can include additional liner weakened separation lines 745 configured as the above described liner weakened separation line 734. The liner weakened separation line 745 generally extends between edges 740, 742. It should be appreciated that the liner weakened separation line(s) could extend horizontally between opposite edges 741a and 741b without departing from the spirit of the present subject matter.

The liner weakened separation line 745 includes a major portion 746 and minor portions 748. FIGS. 21-22 best show that the major portion 746 of the liner weakened separation line 745 underlies the column 730 of strips 726 and is covered by the column of strips. It will be appreciated that the liner weakened separation line 734 includes a similar major portion and a minor portion. As best shown in FIGS. 20 and 22, the minor portion 748 extends between an edge of the sheet 710, 729 and an adjacent strip 726. The minor portion 748 could potentially lie outside of the column of strips and thus does not underlie the column of strips.

Referring to FIG. 19, the major portion 746 of the liner weakened separation lines 734 and 745 includes a linear portion 750 and at least one curved segment 752, with the curved segment preferably including a majority or only cuts. The linear portion 750 is aligned with and is parallel, and adjacent to the linear edge 732 of the column 728 of strips 726. Preferably, the linear portion 750 is adjacent the linear edge 732 of the column 728 of strips 726 so that folding the healthcare sheet 710 along the linear portion toward the release-coated liner 714 results in the strips separating from the release-coated liner 714 along the linear edge 732 of the column 728. In one embodiment, the linear portion 750 is within half an inch (13 mm) of the linear edge 732 of the column 728. In another embodiment, the linear portion 750 is within a quarter of an inch (6 mm) of the linear edge 732 of the column 728. In yet another embodiment, the linear edge 750 is within an eighth of an inch (3 mm) of the linear edge 732 of the column 728. In yet another embodiment, the linear portion 750 is 3/32 of an inch (2.4 mm) from the linear edge 732 of the column 728.

Referring back to FIG. 19, the plurality of die cuts 724 in the facestock 712 forming strips 726 can also form a facestock waste portion 754. Additional weakened separation lines 756 in the facestock 712 can further divide the waste portion into subdivided waste portions 758. The additional weakened separation lines 756 can be continuous die cut lines, or alternatively, can be discontinuous lines, for example, perforations or cuts and ties. In one embodiment, all of the subdivided waste portions remain attached to the release-coated liner 714 (FIG. 20) after manufacture of the healthcare sheet 710 is complete. In another embodiment, at least one of the subdivided waste portions is removed from the release-coated liner.

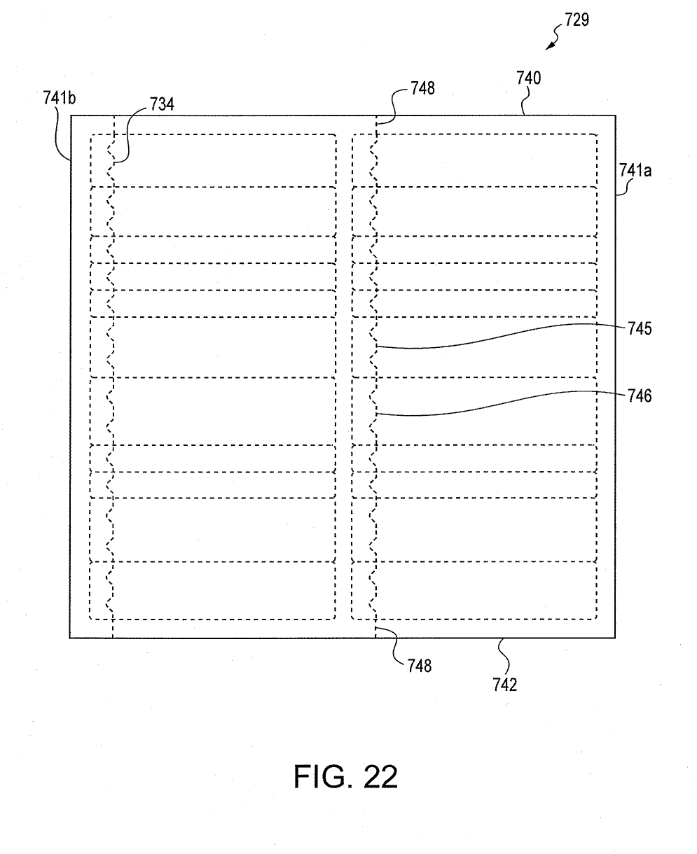

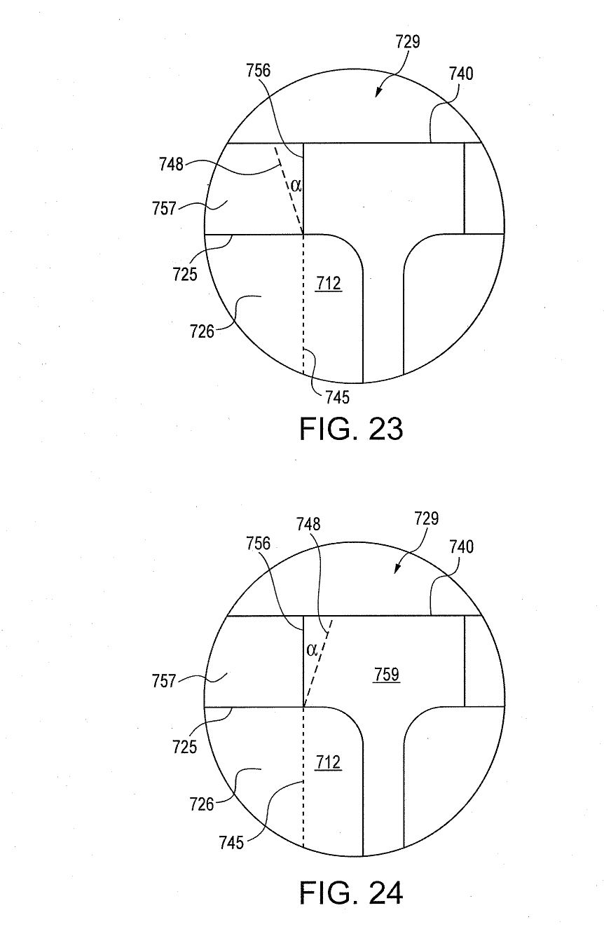

FIGS. 23-26 are alternative embodiments viewed at region A-A on FIG. 21. Turning first to FIGS. 23 and 24, the minor portion 748 of the liner weakened separation line 745 can be seen in relation to the additional weakened separation line 756 in the facestock 712. The projection of the minor portion 748 of the liner weakened separation line 745 onto the plane of the healthcare sheet 729 is shown intersecting the additional weakened separation line 756 in the facestock at the edge 725 of a strip 726 at an angle α. In FIG. 23, the minor portion 748 of the liner weakened separation line 745 underlies a subdivided waste portion 757 that remains on the release-coated liner 714. In FIG. 24, the minor portion 748 of the liner weakened separation line 745 is in a portion 759 of the release-coated liner from which the subdivided waste portion 758 (as described in conjunction with FIG. 19) has been removed. Thus, the minor portion 748 does not underlie the subdivided waste portion. While FIGS. 23 and 24 show the projection of the minor portion 748 of the liner weakened separation line 745 onto the plane of the healthcare sheet 729 intersecting the additional weakened separation line 756 in the facestock at the edge of a strip 726, the minor portion 748 can intersect at a position other than at the edge of a strip.

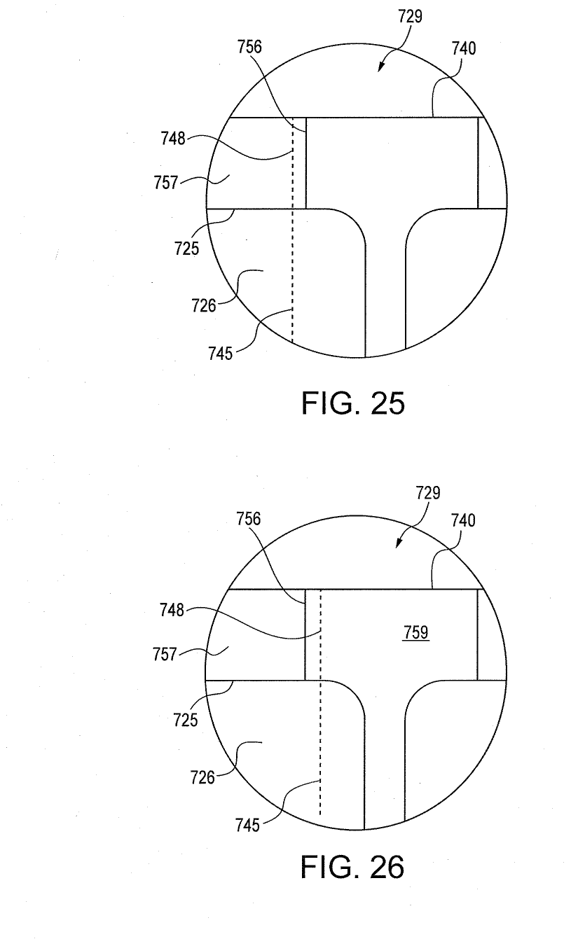

In alternative embodiments, the projection of the minor portion 748 does not intersect the additional weakened separation line 756. FIGS. 25 and 26 illustrate that the projection of the liner weakened separation line 745 and its minor portion 748 onto the plane of the healthcare sheet can be parallel to the additional weakened separation line 756 in the facestock. FIG. 25 shows the projection of the liner weakened separation line 745 onto the plane of the healthcare sheet on one side of the additional weakened separation line 756 in the facestock and is underlying a subdivided waste portion 757 that remains on the release-coated liner. FIG. 26 shows the projection of the liner weakened separation line 745 onto the plane of the healthcare sheet on the other side of the additional weakened separation line 756 (in comparison to the embodiment illustrated in FIG. 25) in the facestock and is in a portion 759 of the release-coated liner above which the subdivided waste portion 758 (as described in conjunction with FIG. 19) has been removed. Thus, the minor portion does not underlie the subdivided waste portion. As can be appreciated from FIGS. 19-22, the projection of the liner weakened separation line 745 onto the plane of the healthcare sheet can be coincident with the additional weakened separation line 756 in the facestock.

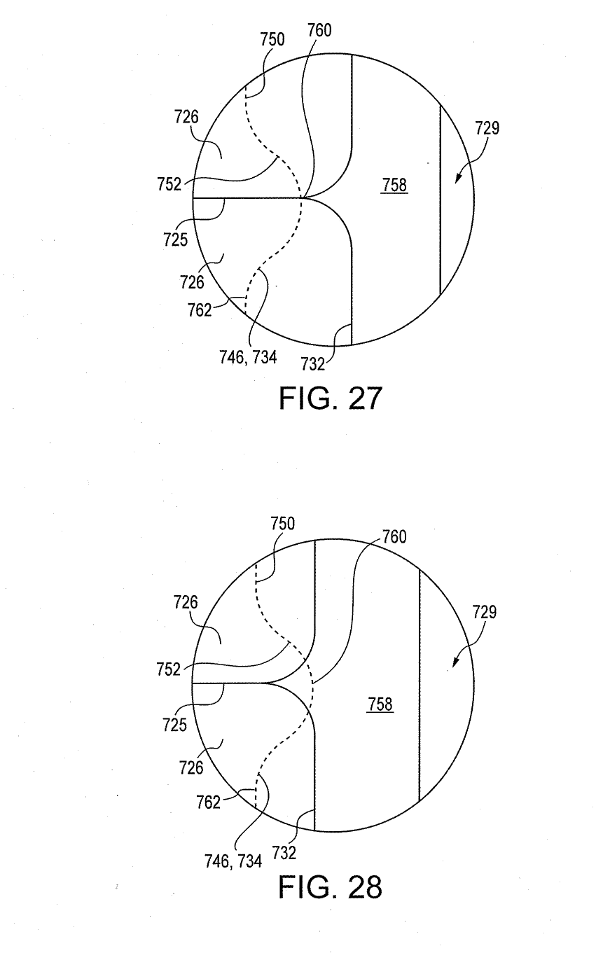

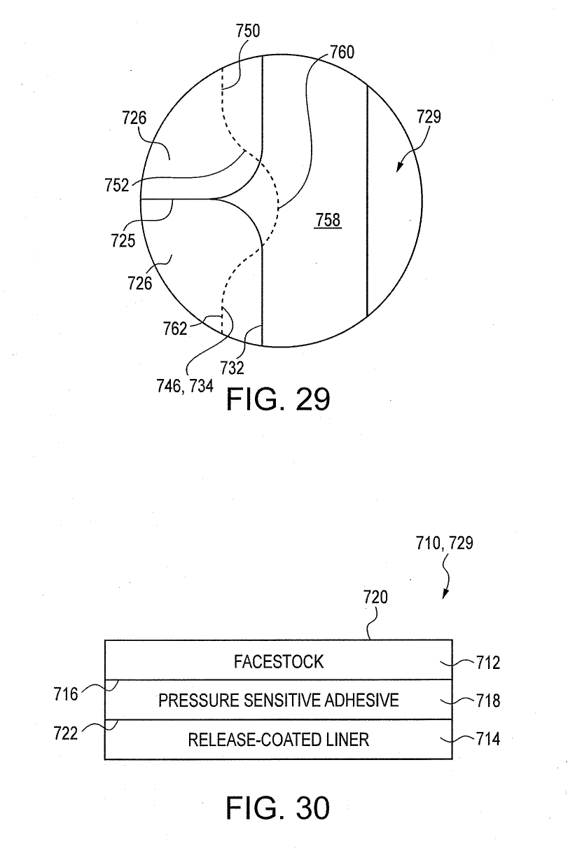

FIGS. 27-29 are alternative embodiments viewed at region B-B on FIG. 21. The at least one curved segment 752 of the major portion 746 of the liner weakened separation line 734 can be characterized as having an apex 760. Many of the embodiments described herein include a liner weakened separation line that includes a plurality of curved segments or apices. The apex 760 of the curved segment 752 is the point of the curved segment 752 that is at the furthest distance from a line 762 defined by the linear portion 750 of the liner weakened separation line 734. FIG. 27 shows that the apex 760 of the curved segment 752 adjacent to the linear edge 732 of the column 730 of strips 726. FIG. 28 shows another embodiment wherein the apex 760 is adjacent to, and extends to, the linear edge 732 of the column 730 of strips 726. FIG. 29 shows yet another embodiment wherein the apex 760 does not underlie the column 730 of strips 726 and extends beyond the linear edge 732. In each of these embodiments, the curved segment 752 is shown spanning two adjacent strips 726. In alternative embodiments, the curved segment 752 spans a strip 726 and the subdivided waste portion 758.

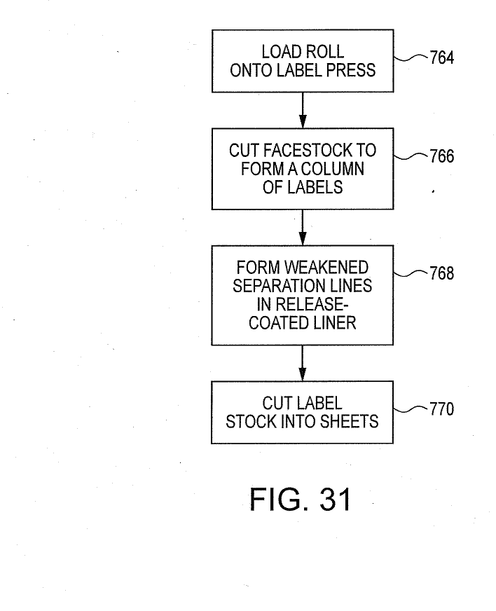

The healthcare sheet 710, 729 described herein and as schematically depicted in FIG. 30, can be manufactured by the following process on conventional label converting equipment known in the art. The process is shown as a flow chart in FIG. 31. A printable sheet for example label stock including a facestock 712 and release-coated liner 714 releasably adhered together with a layer of pressure sensitive adhesive 718 is loaded in roll form onto a label press at step 764. Specifically, adhesive layer 718 and a release face 722 are contacted. The facestock 712 and the adhesive layer 718 contact one another along an interface 716. The facestock 712 defines a print-receiving outer face 720. The label stock can include surface treatments and coatings to enhance printability in laser and inkjet printers, and copiers. The label stock is unrolled into a web on the label press and the facestock is die cut into at least one column 728 of strips 726 at a facestock station at step 766. The facestock can include waste portions 758 defined by additional weakened lines 756 in the facestock that are usually formed at the same time as the column of strips 726 or can be formed at a separate station. The release-coated liner 714 has weakened separation lines 734, 745 formed in it at step 768, usually at a liner station separated from the facestock station. The weakened separation lines on the release-coated liner include major 746 and minor 748 portions described herein, as well as a linear portion 750 and at least one curved segment 752. The weakened separation lines on the release-coated liner are located such that the major portion 746 underlies the column of strips 726. At another station, the web of strip stock is cut into sheets at step 770, typically of sizes suitable for desktop printers and copiers, for example, 8.5 inches by 11 inches (215.9 mm by 279.4 mm), 4 inches by 6 inches (101.6 by 152.4 mm), 8.5 inches by 14 inches (215.9 mm by 355.6 mm), and A4 (8.3 inches by 11.7 inches, 210 mm by 297 mm). The healthcare sheets can be packaged using the label converting equipment or can be packaged using a separate packaging machine.

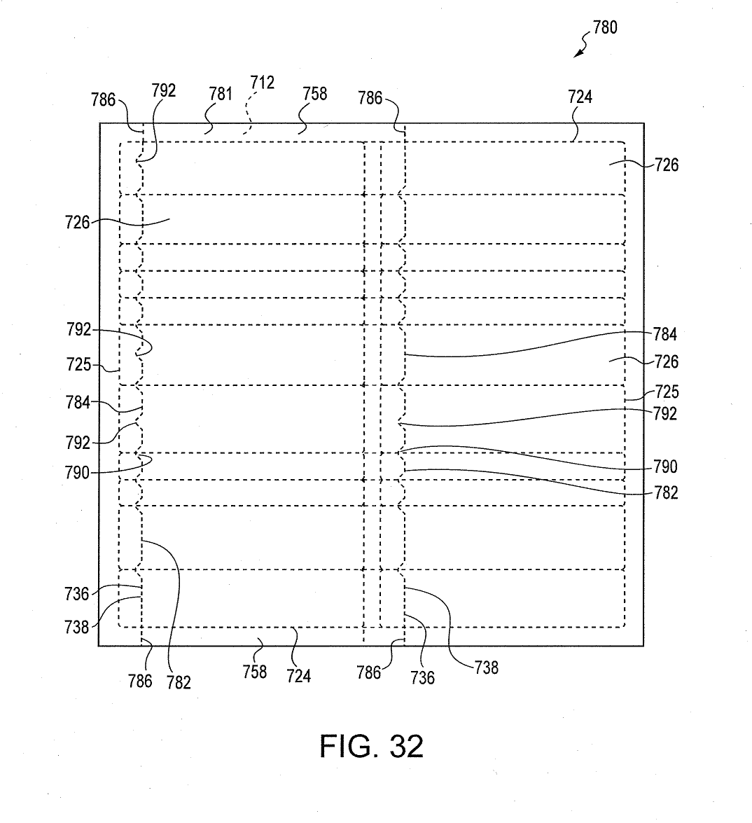

The back side of a healthcare assembly 780 of another embodiment of the current subject matter is shown generally in FIG. 32. The healthcare assembly 780 depicted is similar to the healthcare assembly 729 depicted in FIGS. 21 and 22. A release-coated liner 781 includes liner weakened separation lines 782 that are parallel to and adjacent the edges 725 of strips 726 die cut in the facestock sheet 712. The liner weakened separation lines 782 are formed with a series of cuts 736 and ties 738. The liner weakened separation lines 782 include major portions 784 underneath the strips 726 and minor portions 786 under a waste portion 758 of the facestock sheet.

The major portions 784 of the weakened separation lines 782 include two types of curved segments 790, 792. Both types of curved segments are free of ties, and include only die cuts. Curved segment 790 is similar to curved segment 752 shown in FIGS. 27-29. Curved segment 790 is generally aligned between two adjacent strips 726 and can completely underlie the strips or extend a distance past the edge 725 of the strips 726 as described elsewhere herein. Thus, portions of curved segment 790 span or underlie two adjacent strips 726. Additionally, a curved segment 790 can span or extend across the die cut 724 between a strip 726 and the waste portion 758.

Curved segments 792 can be smaller than curved segments 790 and of a similar shape. Each curved segment 792 completely underlies a single strip 726. As shown in FIG. 32, none, one, or more curved segments 792 typically underlie each strip 726, approximately equally spaced across the strip. However, any number of curved segments 792 can underlie a single strip 726, and the curved segments 792 need not be equally spaced or symmetrically spaced under the strip 726. Additionally, the curved segments 792 can be the same size as, or larger than, the curved segments 790.

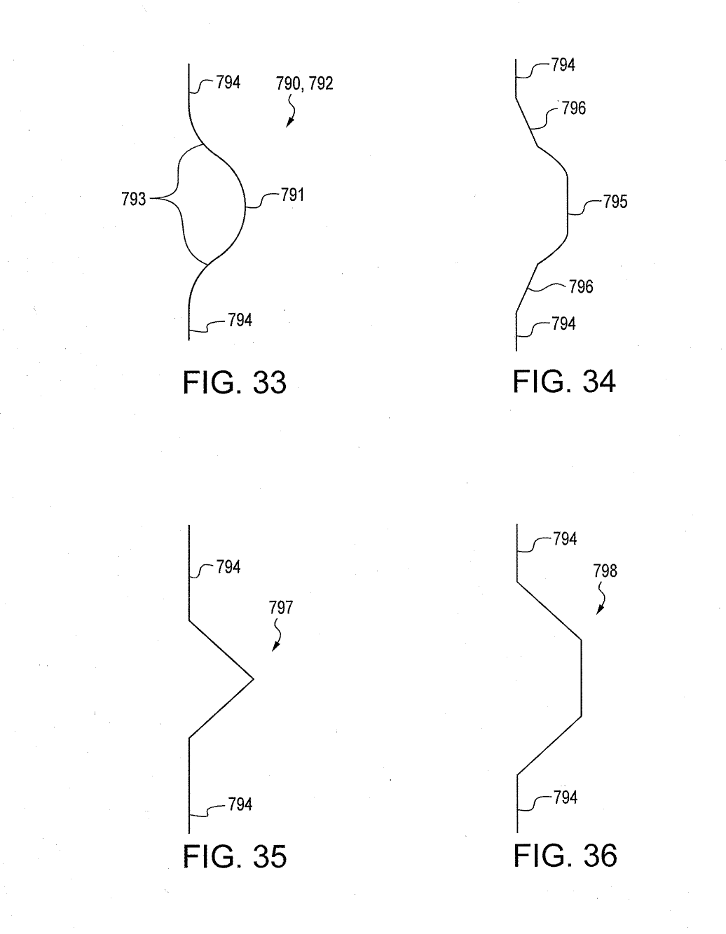

As shown in FIG. 33, the curved segments 790, 792, also referred to as shapes, are rounded. The shapes include rounded apices 791 with rounded transitions 793 to linear portions 794 of the linear weakened separation line 782. Alternative shapes are also useful. For example, as shown in FIG. 34, the apices can be cut off, or truncated, to form linear portions 795 that are parallel, or alternatively, skewed relative to a strip edge 725. One or more transitions 796 extending between the curved segments and the linear portions 794 can be linear as well. Thus, the curved segments need not necessarily be curved and can be square, rectangular, trapezoidal, elliptical, triangular, or other shapes. FIGS. 35 and 36 illustrate embodiments of segments 790 and 792 as triangle-shaped cuts 797 and trapezoid-shaped cuts 798. Additionally, the two types of curved segments 790, 792 can be different shapes within a single linear weakened separation line.

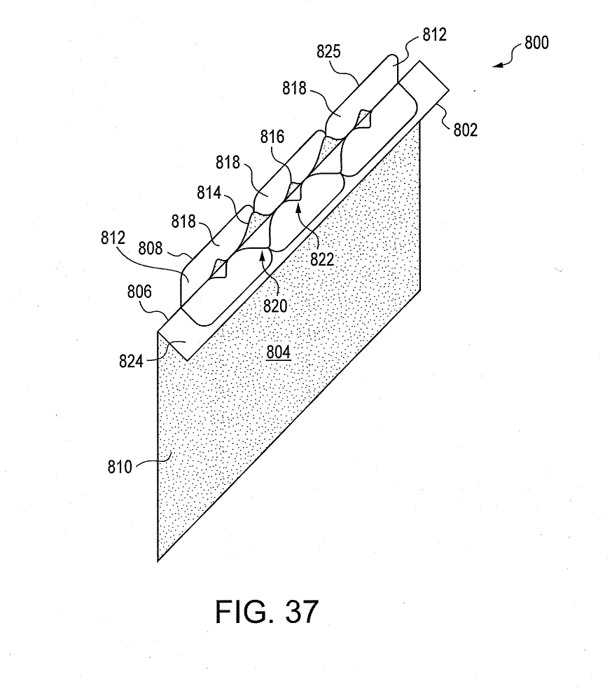

FIG. 37 illustrates a healthcare assembly sheet 800 of another embodiment of the present subject matter. The healthcare sheet is shown with an edge 802 folded toward the release-coated liner side 804 along a linear weakened separation line 806. Folding the edge separates a portion 808 of strips 818 from a release-coated liner 810 and exposes pressure sensitive adhesive 812 on the back side of the strips 818. The strips are easily removed from the healthcare sheet by grasping the partially separated strips and peeling them from the rest of the release-coated liner.

With the linear weakened separation line 806 adjacent an edge 825 of the strips 818, and the apices of the shapes adjacent the edge of the strips, when the edge 802 of the sheet 800 is folded, the relatively stiff strips 818 separate from the release-coated liner 810. The curved portions 814 and 816 of the liner weakened separation line 806 being free of ties, remain adhered to the strips 818, producing holes or apertures 820 and 822, respectively, in the folded edge of the release-coated liner 810. The separated portions 808 of the strips 818 include facestock and adhesive in the areas not covered by the curved portions 814, 816. The areas of the strips 818 covered by the curved portions 814, 816 include facestock 824, adhesive 812 and release-coated liner 810, thereby stiffening that portion of the strip 818 sufficiently to cause separation from the release-coated liner upon folding. The amount of stiffening can be controlled, for example, by altering the sizes of the curved portions, the number of curved portions, and the shape of curved portions. The separation of strips made of thinner, more flexible materials, for example, film strips instead of paper strips, is improved by increasing the number of the curved portions, the increasing size of the curved portions, or by altering the shape of the curved portions, or by any combination of these factors.

As discussed previously, the weakened separation line 806, includes cuts and ties. The lengths of the cuts and the lengths of the ties can vary. Ties can range in length from approximately 0.013 inches (0.33 mm) to approximately 0.050 inches (1.27 mm) long. For example, in one embodiment, the ties are 0.030 inches (0.76 mm) long. Cuts can be any length, with the length of each cut being determined by the spacing between adjacent ties along a weakened separation line. In one embodiment, the cuts have a length from approximately 0.042 inches (1.06 mm) to approximately 0.047 inches (1.19 mm) long. Other lengths of cuts and ties are possible without deviating from the spirit of the subject matter, for example, microperforations can be used, in which the cuts and ties are much smaller. In one embodiment, curved segments are separated from linear first portions by bounding ties. Embodiments with multiple weakened separation lines can have different cut and tie lengths on different weakened separation lines. Additionally, minor portions of the weakened separation lines can have cuts and ties in which the cuts are shorter in length as the weakened separation line approaches the edge of the sheet. Alternatively, in other embodiments, there are no cuts and ties within 0.25 inches (6.35 mm) of the edge of the sheet.

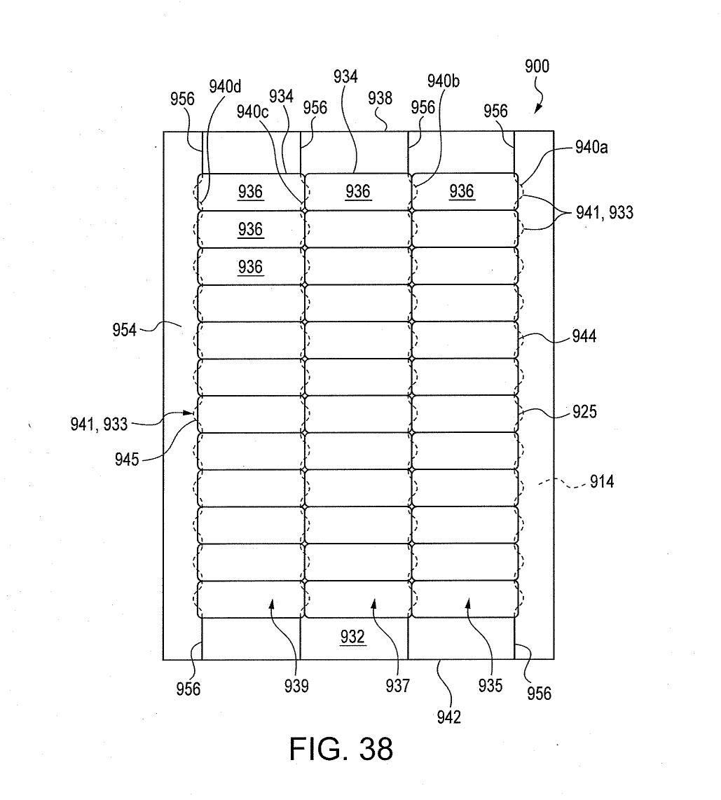

With reference now to FIG. 38, another embodiment of a healthcare assembly sheet 900 is formed of a release-coated liner sheet 914 with a facestock sheet 932 releasably adhered thereto with pressure sensitive adhesive. A plurality of die cut lines 934 are formed in the facestock to define releasable strips 936 therein. The strips 936 include edges 925. The strips 936 are shown as being ordered in a plurality of columns 935, 937, 939 and having a generally rectangular shape, and as such the strips can have any shape. Furthermore, although the strips are shown as abutting adjacent strips, an individual having ordinary skill in the art will understand that this embodiment is typically practiced to obtain the maximum number of strips per healthcare sheet but there is no requirement imposed by the present disclosure that adjacent strips abut one another. Furthermore, in embodiments where adjacent strips do not abut, the area between strips can have facestock thereupon or can be devoid of facestock. Similarly, in the embodiments shown, a border area 954 surrounding the strips 936 can have facestock thereupon or can be devoid of facestock.

Referring further to FIG. 38, healthcare sheet 900 further includes weakened separation lines 940a, 940b, 940c, and 940d in the release-coated liner 914 that extend from a top edge 938 to a bottom edge 942 of the healthcare sheet along a selected edge 944 of each column 935, 937, 939 of strips 936 and are formed with a generally sinusoidal shape 945 that crosses the selected edge of each strip 936 twice. The weakened separation lines collectively referred to herein as 940, partially extend past the selected edge of each respective strip 936 and partially extend beneath the strip. FIG. 38 illustrates three such lines 940a, 940b, and 940c in the release-coated liner 914 that extend along the right edge of each column of strips as well as one weakened separation line 940d in the release-coated liner 914 that extends along the left edge of the leftmost column 939 of strips 936. A corresponding weakened separation line 956 in the facestock 932 is also provided over each portion of each liner weakened separation line that extends from the edge of the healthcare sheet to the nearest strip.

In one embodiment, the weakened separation lines 940a, 940b, 940c, and 940d in the release-coated liner 914 are formed with ties 941 (continuous, or uncut portions), as shown in FIG. 38. In the specific, illustrative, non-limiting embodiment described, the ties 941 are disposed at an apex 933 of the sinusoidal weakened separation line 940 in the release-coated liner 914 where the line extends past the edge 925 of each strip 936. However, in such embodiments where the weakened separation line 940 in the release-coated liner 914 is formed with ties, the ties can be disposed at other locations along the respective line. In other embodiments, there are no ties in the sinusoidal weakened separation line 940 in the release-coated liner 914.

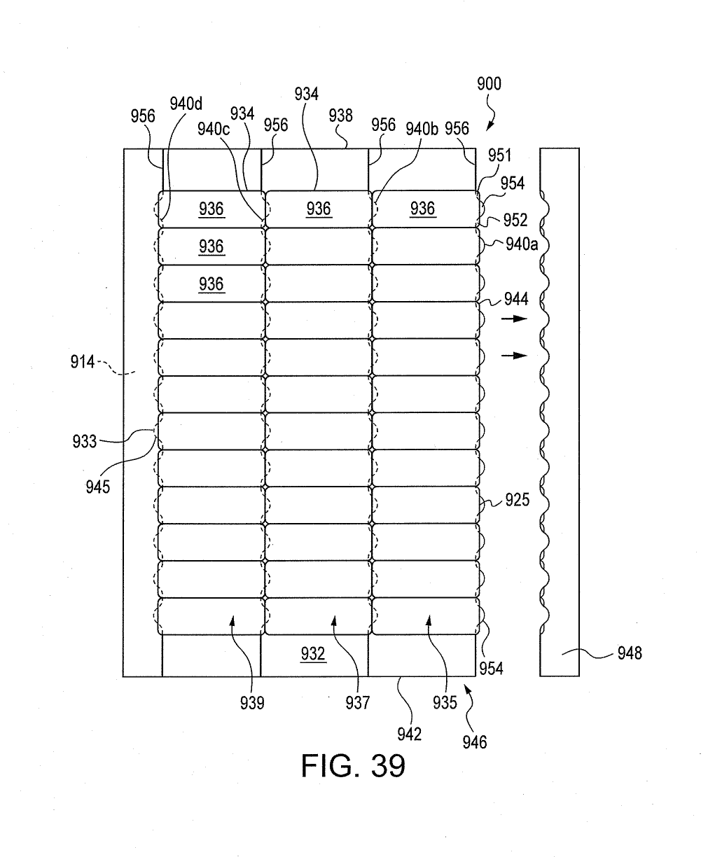

With reference to FIG. 39, the healthcare sheet 900 of the embodiment shown in FIG. 38 can be grasped with one hand on one side of the weakened separation line such as 940a and the other hand on the other side of the selected line (in FIG. 39, the line in the release-coated liner that is right-most in the sheet 900 is selected). The healthcare sheet separates along the selected weakened separation line 940a in the release-coated liner into two pieces 946, 948 when the two hands pull the two pieces apart. The right-most piece 948 of the healthcare sheet separates along the right-most weakened separation line 940a in the release-coated liner 914 as well as the respective weakened separation lines 956 in the facestock 932 from the rest of the healthcare sheet 946. The upper and lower right-hand corners 951, 952 of each strip 936 in the right-most column 935 of strips are exposed thereby facilitating the grasping and peeling of the respective strip off the release-coated liner sheet. The separation of the right-most piece 948 of the healthcare sheet 900 also leaves portions 954 of the release-coated liner exposed that correspond to the portions of the weakened separation line 940a in the release-coated liner that extend beyond the edge 925 of each strip 936. These exposed release-coated liner portions can also aid the user in separating the respective strip by allowing the user to grasp the exposed release-coated liner portion and peel it back or away from the strip, which can also be done concurrently with grasping a corner of the strip and peeling forward or away from the release-coated liner.

In the manner described above, each column 935, 937, 939 of strips 936 can be individually separated from an adjacent column of strips prior to removing the strips therefrom. Additionally, in an embodiment that includes a weakened separation line 940d in the release-coated liner 914 formed along the left edge of the left-most column of strips as shown in the embodiment of FIG. 39, the process can also begin by separating the left-most portion of the healthcare sheet 900 from the rest of the healthcare sheet. As shown, such a left-most weakened separation line in the release-coated liner would preferably be essentially a mirror image of a right-most weakened separation line in the release-coated liner.

The generally sinusoidal shape 945 of the weakened separation lines 940a and 940d for example in the release-coated liner 914 shown in FIGS. 38 and 39 is for illustration purposes only. In additional embodiments, liner weakened separation lines can be formed along any other practical path provided that they enable the separation of each portion of the healthcare sheet 900 from an adjacent portion (e.g., 946, 948) with relative ease and without tearing of the release-coated liner 914 or of the facestock 932 along any path other than along the weakened separation lines and leaving at least a portion such as corner portion 951, 952 along the edge 925 of each strip 936 exposed for ease of separation from the release-coated liner. Furthermore, the overall shapes, the actual dimensions, period, and amplitude of the cuts in the release-coated liner can vary according any of a number of factors, including the thickness of the release-coated liner and the facestock, the depth and/or type of the respective cuts, the strength of the adhesive, aesthetics, etc.

In an alternative method of use, a portion of the healthcare sheet 900 can be bent back along a selected weakened separation line in the release-coated liner such as along 940a, 940b, 940c, and/or 940d thereby forcing the edges 925 of the respective strips 936 to “pop up” off the release-coated liner 914 and allow them to be grasped. The embodiments of weakened separation lines 940 in the release-coated liner 914 that do not have ties 941 at each apex 933 are typically more conducive to being easily bent back than the embodiments of weakened separation lines 940 in the release-coated liner 914 that are formed with ties therein.

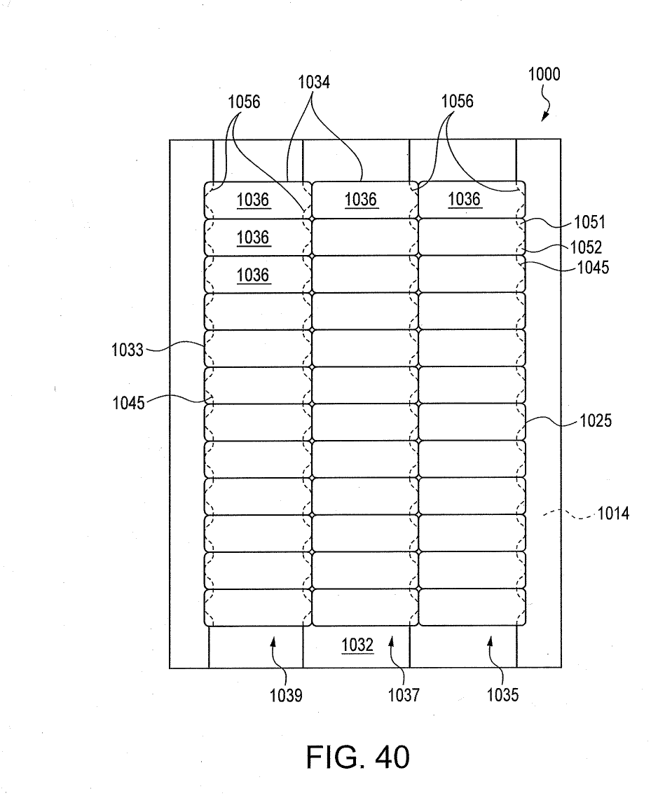

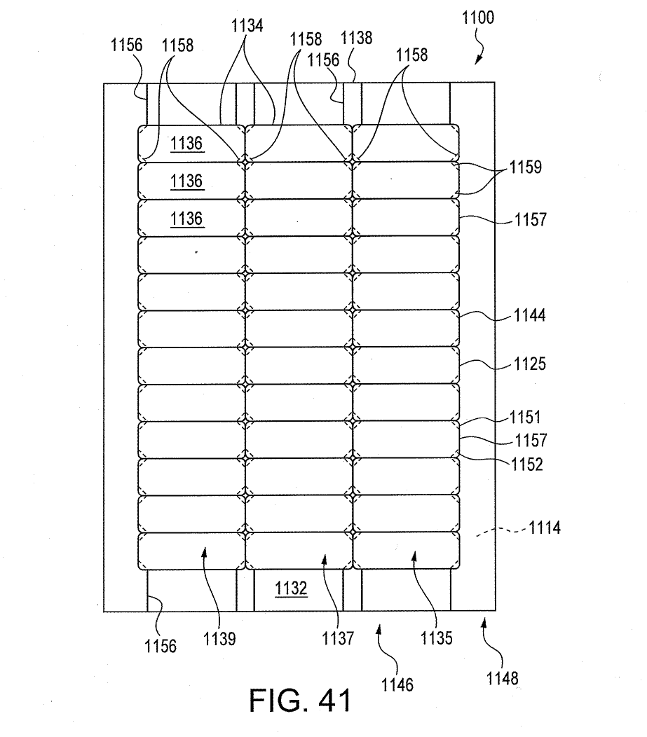

With reference now to FIG. 40, in a further alternative, illustrative embodiment of a healthcare assembly sheet 1000 that is similar to the embodiment of FIG. 38, weakened separation lines collectively designated as 1056 in a release-coated liner 1014 can be formed with the same generally sinusoidal shape 1045 discussed previously with respect to weakened separation lines 940a-940d shown in FIG. 38, but are disposed underneath each column 1035, 1037, 1039 of strips 1036 such that an apex 1033 of the weakened separation line 1056 in the release-coated liner 1014 does not reach beyond, but rather generally coincides with, an edge 1025 of the respective strip. A plurality of die cut lines 1034 are formed in a facestock layer 1032. This embodiment, as with the embodiment of FIG. 41 discussed herein, will therefore not expose any portion of the release-coated liner 1014 when the healthcare sheet is separated into portions along the weakened separation lines in the release-coated liner, and will provide exposed corners 1051, 1052 of each strip 1036 for ease of removal as described herein. Weakened separation lines in the release-coated liner can be formed with or without ties, as discussed elsewhere herein.

In another illustrative alternative embodiment 1100, shown in FIG. 41, weakened separation lines collectively designated as 1158 are cut in a release-coated liner 1114 to extend from a top edge 1138 of the healthcare sheet 1100 along each edge 1144 of each column 1135, 1137, 1139 of strips 1136. The lines 1158 are formed with a periodic shape composed of generally straight angular segments 1159 that extend at an angle between the top and bottom edge of each strip 1136 to the side edge of the respective strip, to thereby define corners 1151, 1152 that will be subsequently exposed upon separation of the healthcare sheet into two portions 1146, 1148, and generally straight vertical segments 1157 that extend along an edge 1125 of each strip between the corresponding angular segments to define a single, continuous weakened separation line 1158 in the release-coated liner 1114. Providing such a line in the release-coated liner 1114 along each edge of each column of strips 1136 provides a choice to the user as to which column of strips to use first, but it must be understood that a single weakened separation line in the release-coated liner can be provided for each column of strips, which can be formed underneath either of the left or right edge of each column of strips. A plurality of die cut lines 1134 are formed in a facestock layer 1132. As with the previous embodiments, a corresponding weakened separation line 1156 in the facestock 1132 is also provided over each portion of each liner weakened separation line 1158 that extends from an edge such as the edge 1138 of the healthcare sheet 1100 to the nearest strip 1136. This embodiment will thus not expose any portion of the release-coated liner 1114 when the healthcare sheet is separated into portions along the weakened separation lines in the release-coated liner but will provide exposed corners of each strip for ease of removal as described previously.

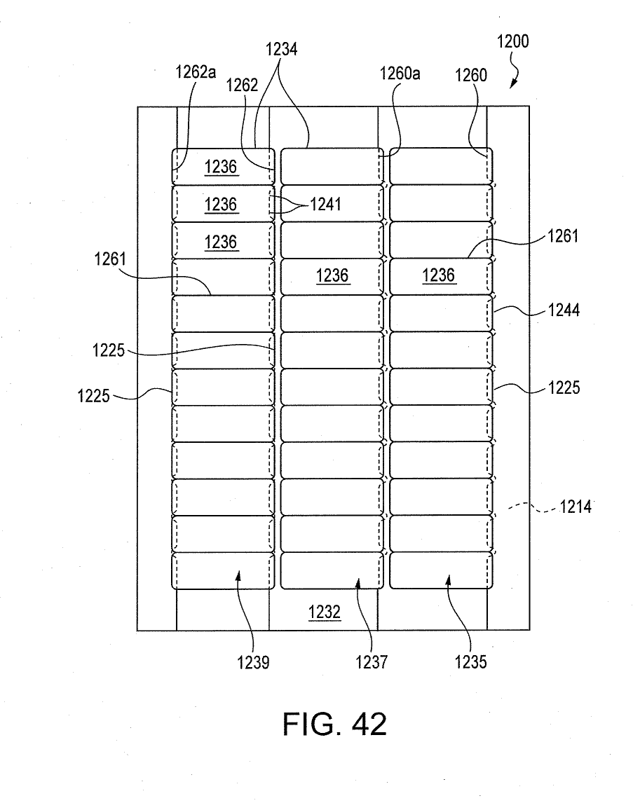

In still another embodiment, as shown in FIG. 42, a healthcare assembly sheet 1200 includes a plurality of die cut lines 1234 in a facestock 1232 to define strips 1236. The healthcare sheet 1200 is formed with weakened separation lines 1260, 1260a in a release-coated liner 1214 that extend generally parallel to and spaced from an edge 1244 of each column 1235 and 1237 of strips 1236 and beneath each strip, but extend beyond the edge 1225 of each strip at an interface 1261 between adjoining strips. In this embodiment, the weakened separation lines 1260, 1260a in the release-coated liner 1214 also extend beyond the edge 1244 of the respective column of strips as they extend past the edge 1225 of each strip 1236. The embodiment of the weakened separation line 1260 in the release-coated liner 1214 is formed with ties 1241 along the straight segments whereas the embodiment of the weakened separation line 1260a does not include any ties (although a dashed line is depicted for line 1260a).

In still another embodiment, also shown in FIG. 42, weakened separation line 1262 in the release-coated liner 1214 is similar to weakened separation lines 1260, 1260a but as the line 1262 extends past the edge 1225 of each strip 1236 at the interface between adjoining strips it does not extend beyond the edge 1244 of the respective column 1239 of strips 1236. The weakened separation line 1262 in the release-coated liner 1214 is formed with ties 1241 in the straight segments thereof, similar to weakened separation line 1260 in the release-coated liner 1214. Another embodiment of a weakened separation line 1262a in the release-coated liner 1214 extends along the left-most edge of the left-most column 1239 of strips 1236 in the healthcare sheet 1200 and also does not extend beyond the edge of the respective column of strips as the line 1262a extends past the edge 1225 of each strip 1236 at the interface 1261 between adjoining strips, but does not include ties, similar to weakened separation line 1260a in the release-coated liner (although line 1262a is shown as a dashed line). As described hereinabove, weakened separation line 1262a in the release-coated liner 1214 is essentially a mirror image of weakened separation line 1262 in the release-coated liner 1214. In use of the embodiments of FIG. 42, the user can choose to tear the healthcare sheet apart along a selected weakened separation line in the release-coated liner or bend it backwards, as previously discussed.

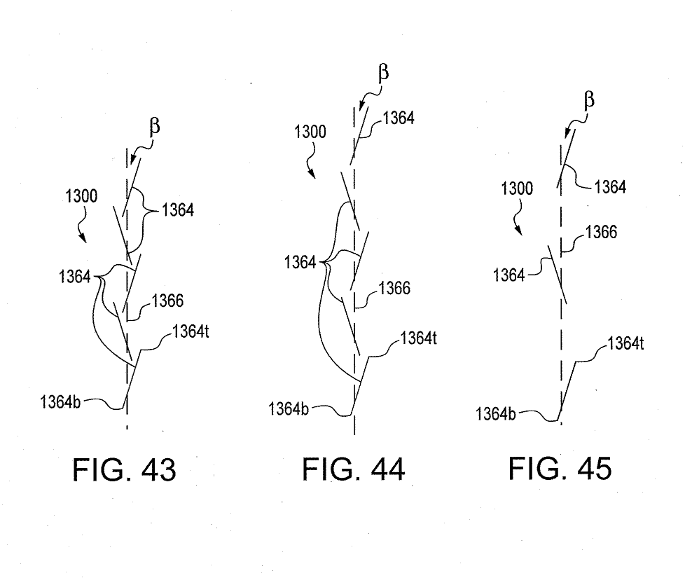

With reference now to FIGS. 43-51, in further embodiments, a cut 1300, 1320, 1340, 1360 in a release-coated liner of any of the healthcare sheets noted herein is provided to tear the healthcare sheet into two or more portions as previously disclosed. This cut can be formed by die cutting, scoring, or microperforations, as previously disclosed, or by any other practicable method.

Liner separation cuts known in the art are comprised of a single continuous cut line, along which separation occurs. Other liner separation cuts known in the art include a plurality of cut segments interspersed by ties that are all aligned on a single continuous line in an end-to-end fashion. In both of these cases, the separation path and the cuts are coincident, meaning the separation path and the cuts lie on the same line. The embodiments shown in FIGS. 43-51 have at least portions of cuts that do not lie on the separation path. In further embodiments, the cut segments are not linear segments but rather are complex shapes consisting of several linear segments joined together.

One illustrative embodiment is shown in FIG. 43. A separation line 1300 that can be cut in a release-coated liner of a healthcare sheet as described elsewhere hereinabove is composed of a plurality of individual cut segments 1364 that are disposed along, and at an acute angle β to, a separation path 1366 (shown as a dashed line), along which the separation is selected to occur when the healthcare sheet is torn as described hereinabove. Each individual cut segment has a top end 1364t and a bottom end 1364b, with the cut segments disposed relative to one another such that the top end of each segment is at the same point on the separation path as the bottom end of the immediately adjacent segment. In other embodiments, the segments can be disposed so that their respective adjacent ends are less far along the separation path, as shown in the embodiment of FIG. 44, or alternatively can be disposed so that their respective adjacent ends are farther along the separation path as shown in FIG. 45. To separate along the separation path using any of the embodiments of FIGS. 43-45, the healthcare sheet is torn as previously described.

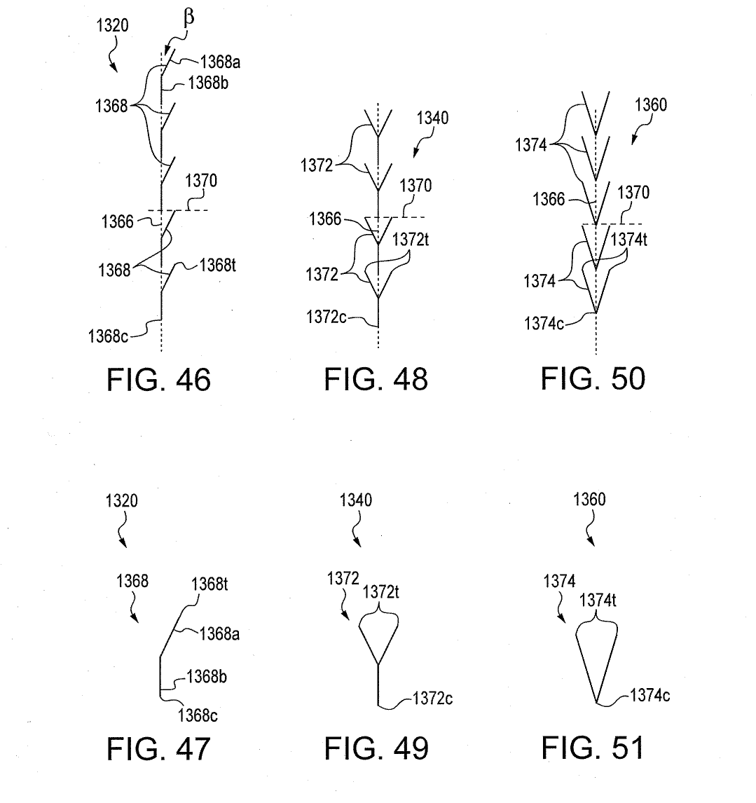

With reference to FIGS. 46 and 47, in an alternative embodiment, a separation line 1320 is composed of a plurality of cut shapes 1368 disposed along a selected separation path 1366, each shape is composed of two cut segments 1368a, 1368b joined end-to-end. The shapes are disposed along the separation path with the same segment 1368b aligned on the separation path, and the segment 1368a is at an angle β to the separation path, such that each shape appears as half of a “Y” shape and includes a top end 1368t and a bottom end 1368c. The shapes can be disposed such that the bottom end of each shape and the top end of the immediately adjacent shape are aligned on an imaginary line 1370 perpendicular to the separation path. In alternative embodiments, the bottom end of a shape and the top end of the immediately adjacent shape do not lie on the imaginary line.

The embodiment of FIGS. 48 and 49 is similar to the embodiment of FIG. 46 in that a separation line 1340 is composed of a plurality of cut shapes 1372 disposed along a selected separation path 1366. The cut shapes of this embodiment have a generally “Y” shaped configuration, with the top of the fork of the “Y” defining a top end 1372t of each shape and the bottom of the leg of the “Y” defining a bottom end 1372c of the shape. The shapes are disposed along the separation path with the leg of each “Y” shape aligned on the separation path. The shapes can be disposed such that the top end of a shape and the bottom end of the immediately adjacent shape are aligned on an imaginary line 1370 perpendicular to the separation path. In alternative embodiments, the bottom end of a shape and the top end of the immediately adjacent shape do not end on the imaginary line.

The embodiment of FIGS. 50 and 51 is similar to the embodiments of FIGS. 46 and 47 in that a separation line 1360 is composed of a plurality of cut shapes 1374 disposed along a selected separation path 1366. The cut shapes of this embodiment have a generally “V” shaped configuration, with the top of the fork of the “V” defining a top end 1374t of each shape and the tip of the “V” defining a bottom end 1374c of the shape. The shapes are disposed along the separation path with the tip of each “V” shape disposed on the separation path and the arms of the “V” extending at equal angles to the separation path. The shapes can be disposed such that the top end of a shape and the bottom end of the immediately adjacent shape are aligned on an imaginary line 1370 perpendicular to the separation path. In alternative embodiments, the bottom end of a shape and the top end of the immediately adjacent shape do not end on the imaginary line.

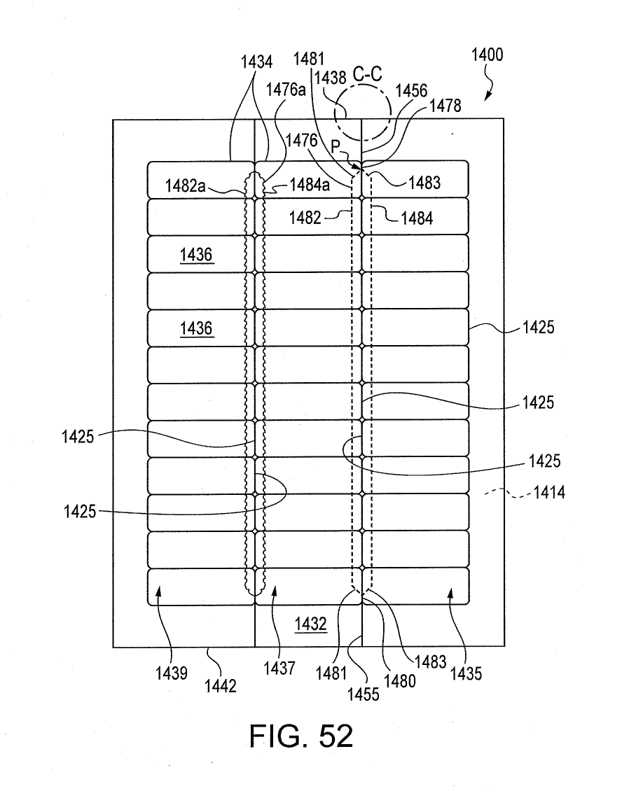

In another embodiment and as illustrated in FIG. 52, a healthcare assembly sheet 1400 can be formed with a plurality of strips 1436 as described elsewhere herein. A plurality of die cut lines 1434 are provided in facestock layer 1432. In the present embodiment, the healthcare sheet is further formed with a set of weakened separation lines 1476 cut in a release-coated liner 1414 to aid in tearing the healthcare sheet into two or more portions and thereby expose the edges 1425 of a column 1435, 1437, and 1439 of strips 1436 for easy removal thereof. In this particular embodiment, liner weakened separation lines 1476 are composed of cut segments 1478 and 1480, underlying weakened facestock lines 1456 and 1455, respectively, and extending from each of the top 1438 and bottom 1442 edge, respectively, of the healthcare sheet 1400 to a point P between two adjacent strips in two adjacent columns of strips. The separation lines 1476 also include substantially parallel weakened separation lines 1482, 1484. Weakened separation line 1482 extends between the two cut segments 1478, 1480 and underneath one of the columns of strips, and weakened separation line 1484 extends between the two cut segments 1478, 1480 and underneath the other column of strips. Angled cut segments 1481, 1483 connect the weakened separation lines 1482, 1484 with the cut segments 1478, 1480. It will be understood that the weakened separation lines 1482, 1484 can be formed in any of the embodiments disclosed herein or known in the art. A pair of corresponding weakened separation lines 1482a, 1484a associated with another set of separation lines 1476a are also shown in FIG. 52. Weakened separation lines 1476, 1482, 1484 are shown to be essentially straight, linear cuts, whereas weakened separation lines 1482a, 1484a of weakened separation lines 1476a are essentially separation paths along which a plurality of cut segments formed in accordance with the embodiment of FIG. 45 are disposed. The weakened separation lines 1482, 1484 can also be formed in a generally sinusoidal pattern as also disclosed herein, and can be formed with or without ties therein. As discussed hereinabove, a corresponding weakened separation line in the facestock 1432 is also provided over each portion of each cut segment.

An advantage conferred by the embodiments of FIG. 52 is that the healthcare sheet 1400 can be torn apart to expose either of the two columns of strips straddled by each set of separation lines 1476 or 1476a simply by choosing which of the two portions to pull and push away. For instance, looking at the label sheet 1400 from the facestock 1432 side and grasping the healthcare sheet with the user's right hand on the right side of separation line 1478, and the user's left hand on the left side of the separation line, the healthcare sheet can be separated to expose the left edges of the rightmost column 1435 of strips 1436 by holding the left hand still and moving the right hand toward the user's body. Alternatively, holding the user's right hand still and moving the left hand toward the user's body exposes the right edges of the center column 1437 of strips.

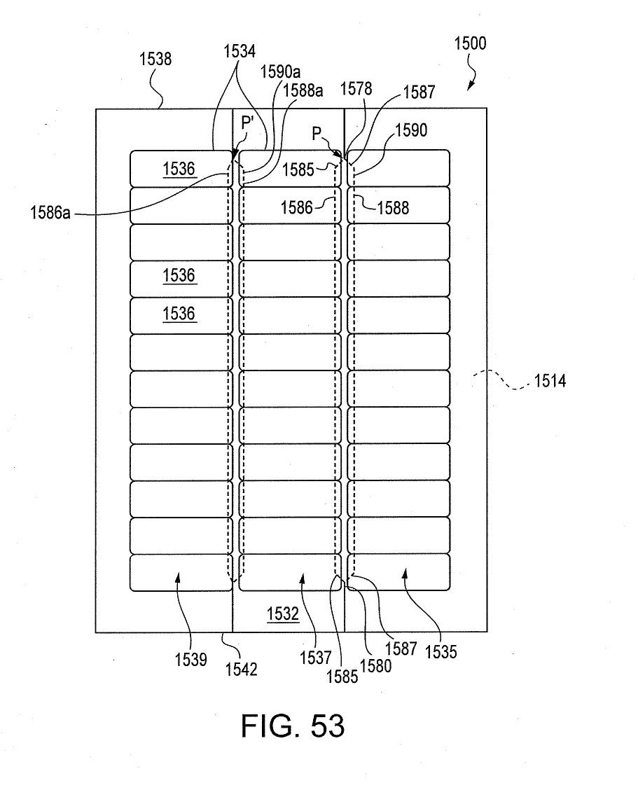

In a variation on the above embodiment shown in FIG. 53, the columns 1535, 1537, 1539 of strips 1536 on a healthcare assembly sheet 1500 are separated as previously shown and discussed in the embodiment of FIG. 52. The healthcare sheet 1500 defines a plurality of die cut lines 1534 formed in a facestock layer 1532. As previously described, the area between the columns of strips can have facestock 1532 disposed over a release-coated liner 1514. In alternative embodiments, the area between the columns of strips can be devoid of facestock disposed over the release-coated liner. As shown in FIG. 53, in one embodiment, a set of weakened separation lines 1590 includes weakened separation line segments 1578, 1580, which extend from each of the top 1538 and bottom 1542 edges of the healthcare sheet 1500 to a point P, between adjacent strips in two adjacent columns of strips, and two substantially parallel weakened separation lines 1586, 1588, each extending between the two cut segments 1578, 1580. Weakened separation line 1586 extends between the two cut segments 1578, 1580 and underneath one of the columns of strips, and weakened separation line 1588 extends between the two cut segments 1578, 1580 and underneath the other column of strips. Angled cut segments 1585, 1587 connect the weakened separation lines 1586, 1588 with the cut segments 1578, 1580. In this embodiment the point P is also disposed between the two columns of strips. In an alternative embodiment, a set of separation lines 1590a is formed similarly to separation line 1590 but the point P′ where the two substantially parallel weakened separation lines 1586a, 1588a intersect the cut segments 1578, 1580 is disposed underneath the edge of the topmost and bottommost strips. To require the same amount of effort to separate the healthcare sheet in either direction, it is desirable that the two substantially parallel weakened separation lines are spaced an equal amount from the edge of the respective column of strips, as shown in the figure.

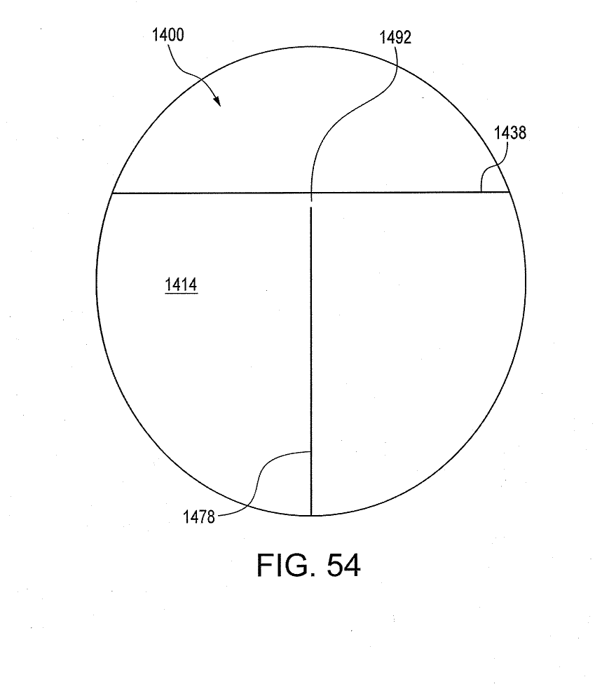

In an alternative embodiment detailed in FIG. 54, the weakened separation line in the release-coated liner, etc. of any of the embodiments disclosed herein does not reach the edge 1438 of the release-coated liner 1414 but rather ends in a tie 1492 adjacent to the edge. FIG. 54 depicts the detail of the embodiment healthcare sheet 1400 at region C-C shown in FIG. 52 from the back side (i.e. looking at the release-coated liner 1414, not the facestock 1432). The provision of a small tie 1492 between the edge of the sheet 1438 and the liner cut 1478 can help prevent premature tearing of the healthcare sheet, for example, while feeding the healthcare sheet through a printer.

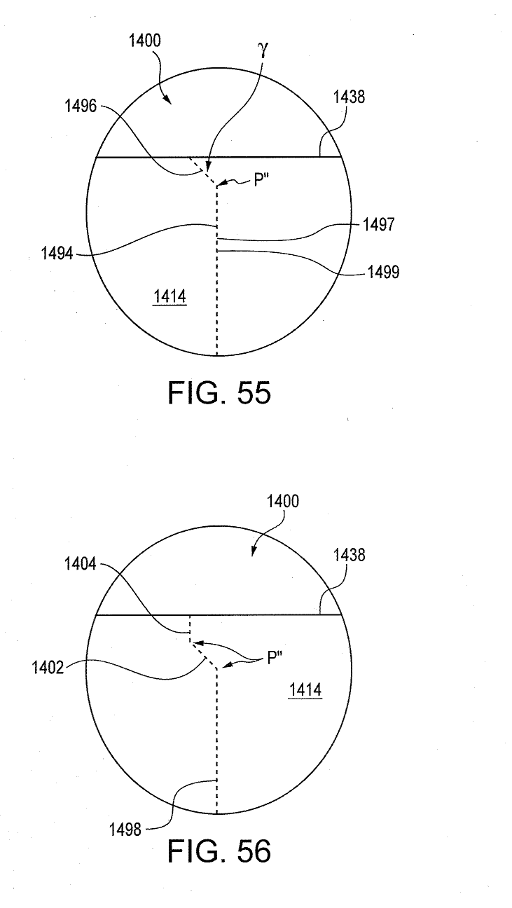

In a still further embodiment of a liner cut 1494 as shown in FIG. 55, which also depicts a healthcare sheet 1400 at region C-C shown in FIG. 52 from the back side (release-coated liner 1414 side), the liner cut 1494 intersects the edge 1438 of the release-coated liner at an angle γ other than 90° to help minimize inadvertent tearing of the healthcare sheet during handling. Thus, as shown, the liner cut 1494 is formed with an angled segment 1496 at its end where it intersects the edge of the release-coated liner. The angled segment intersects the liner cut 1494 at a point of inflexion P″. Such an embodiment can be advantageous with an embodiment of a healthcare sheet where the strips extend to the edge of the healthcare sheet and there is no matrix of release-coated liner or release-coated liner and facestock surrounding the columns of strips. The angled portion of the liner cut that intersects the healthcare sheet edge will allow easy separation and also help minimize or prevent inadvertent tearing due to handling. In embodiments where the liner cut is formed of a plurality of cut segments 1499 interspersed with ties 1497 (as shown in FIG. 55) rather than a single continuous line and the strips extend to the edge of the sheet, it is desirable that a cut segment extend to the edge of the release-coated liner/healthcare sheet rather than a tie. Similarly, in such an embodiment, it is preferable that the point of inflexion P″ of the liner cut also be defined by an uninterrupted cut segment (as also shown in FIG. 55) with no ties therebetween to help the change in direction of the tearing force applied during separation of the healthcare sheet.

In a variation as shown in FIG. 56, a liner cut 1498 is formed with a segment 1404 at the end that intersects the edge 1438 of the release-coated liner 1414 perpendicularly, but which is offset from, and connected to, the liner cut by an angled segment 1402. In embodiments where the liner cut is formed of a plurality of cut segments interspersed with ties (as shown in FIG. 56) rather than a single continuous line and the strips extend to the edge of the sheet, it is desirable that a cut segment extend to the edge of the release-coated liner/healthcare sheet rather than a tie. Similarly, in such an embodiment, it is preferable that the points of inflexion P″ where the liner cut changes direction be defined by an uninterrupted cut segment (as also shown in FIG. 56) with no ties therebetween to help the change in direction of the tearing force applied during separation of the label sheet.

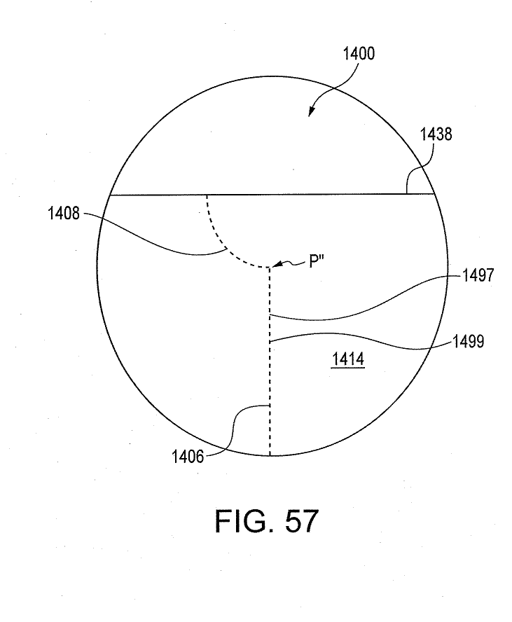

In another variation as shown in FIG. 57, a liner cut 1406 is formed with a curvilinear segment 1408 at the end that intersects the edge 1438 of the release-coated liner 1414 at 90°, and which connects to the liner cut at an inflexion point P″. In embodiments where the liner cut is formed of a plurality of cut segments 1499 interspersed with ties 1497 (as shown in FIG. 57) rather than a single continuous line and the strips extend to the edge of the sheet, it is desirable that a cut segment extend to the edge of the release-coated liner/healthcare sheet rather than a tie. Similarly, in such an embodiment, it is preferable that the points of inflexion P″ where the liner cut changes direction be defined by an uninterrupted cut segment (as also shown in FIG. 56) with no ties therebetween to help the change in direction of the tearing force applied during separation of the healthcare sheet. It must be understood that the embodiments of FIGS. 55-57 can also be formed with liner cuts that are continuous die cuts, scores, or microperforations. Inflection points P″ are shown as angle, however, the angled segment or curvilinear segment can intersect the liner cut in a curved manner to further direct the change in direction of the tearing force.

In all of the noted embodiments, the carrier sheet can be comprised of paper, polymer film, or a combination thereof. The carrier sheet may be transparent to permit visibility of the printable sheet through the carrier sheet, as well as through other layers between the carrier sheet and the printable sheet. Thus, the use of transparent polymer films as the carrier sheet is contemplated. In other embodiments, the carrier sheet may be opaque or comprise one or more coloring agents such as whitening agents or pigments. Translucent carrier sheets are also contemplated. The outer surface or underside of the carrier sheet may have a release coating adhered to it to facilitate stacking of the products. Any release coating known in the art can be used. Silicone release coatings are especially useful. Untreated polyester film can be used. The carrier sheet typically has a thickness of from about 6.4 microns (about 0.25 mils) to about 2.5 microns (about 0.1 mils), and in one embodiment about 13 microns (about 0.5 mils) 0.5 to about 125 microns (about 5 mils), and in one embodiment about 50 microns (about 2 mils).

Pressure sensitive adhesives suitable for use with the present subject matter include permanent, removable, repositionable or other adhesives or combinations thereof that may meet the particular needs of the end use application. For example, a removable adhesive may be used to secure a section of medical tubing to a patient's arm such as with an intravenous (IV) tube. It should be understood that the assembly can be provided with a single type of adhesive, or alternatively, different types of adhesive can be applied to the form in order to serve different functions. For example, certain removable strips (which will be described herein) can be provided with a permanent adhesive and other types of removable strips can be provided with a removable adhesive.

The printable sheet can be comprised of paper, polymer film, fibrous materials, or combinations thereof. A preferred material for use as the printable sheet is a nonwoven material. Medical grade nonwoven materials are well known in the art and commercially available from a wide array of suppliers. The printable sheet can be coated selectively with a print binder material such as polyvinyl alcohol to help the toner or ink adhere to the surface of the sheet. In addition, the entire assembly can be coated or provided with an antimicrobial material to reduce potential contamination.

The deadening material, if used, can be comprised of paper, polymer film, fibrous materials, or combinations thereof. Preferably, the deadening material is formed from the same material as the printable sheet, and thus is preferably a nonwoven material.

In certain embodiments, due to the size and orientation of the printable sheet as compared to the carrier sheet, numerous benefits are provided by the healthcare form assembly. For example, the printable sheet is more easily separated from the carrier sheet than if the printable sheet and the carrier sheet were the same size. This is especially helpful when the healthcare provider completing this task is wearing surgical gloves. Specifically, since the healthcare provider is able to separate the printable sheet from the carrier sheet without removing their gloves, the risk that the healthcare provider is exposed to harmful pathogens is reduced.

Another advantage of the size and orientation of the printable sheet is as follows. In emergency medical situations, time can be of the essence. Accordingly, it is desirable that any medical product be able to be used on the medical patient in a rapid manner. In certain embodiments, because of the size and orientation of the printable sheet as compared to the carrier sheet, the printable sheet can rapidly be removed from the carrier sheet and used on the patient with a minimum amount of delay.

The aforementioned size and orientation of the printable sheet with respect to the carrier sheet allows the healthcare assembly form to be used in a variety of environments where a traditional healthcare assembly form could not be used. In particular, the leading edge provides tactile feedback to the healthcare provider, thereby allowing the healthcare assembly form to be used when visibility is decreased. As can be appreciated, there are numerous instances where there is decreased visibility, including for example low light environments in military field hospitals or in ambulance type vehicles. It will thus be seen according to the present subject matter a highly advantageous healthcare assembly has been provided.

All patents, published applications, and articles noted herein are hereby incorporated by reference in their entirety.

While the subject matter has been described in connection with what is presently considered to be the most practical and preferred embodiments, it will be apparent to those of ordinary skill in the art that the subject matter is not to be limited to the disclosed embodiments, and that many modifications and equivalent arrangements may be made thereof within the scope of the subject matter, which scope is to be accorded the broadest interpretation of the appended claims so as to encompass all equivalent structures and products. It is particularly contemplated that one or more features or aspects of any one or more embodiments described herein, can be combined with one or more other features or aspects of other embodiments.

What is claimed is:

1. A healthcare form assembly comprising:
a carrier sheet defining a leading edge and an oppositely disposed trailing edge;
a release coating disposed on the carrier sheet;
an adhesive layer disposed on the release coating;
a printable sheet having a same or substantially the same shape as the carrier sheet and being removably disposed on the carrier sheet, the printable sheet defining a first set of cut lines, and another set of transversely extending cut lines to thereby define a plurality of removable strips;
wherein the carrier sheet defines at least one weakened separation line, the weakened separation line including a plurality of apices and the weakened separation line at least partially extending across at least a portion of the plurality of removable strips.

2. The healthcare form assembly of claim 1 wherein at least a portion of the cut lines extend substantially parallel to a leading edge of the printable sheet to thereby create a first peel zone along the leading edge of the printable sheet, the healthcare form assembly also comprising a strip or section of a layer of a deadening material disposed in the first peel zone.

3. The healthcare form assembly of claim 2 wherein the printable sheet defines another set of cut lines extending substantially parallel to the leading edge of the printable sheet and spaced from the first peel zone to thereby create a second peel zone.

4. The healthcare form assembly of claim 3 further comprising another strip or section of a layer of a deadening material disposed in the second peel zone.

5. The healthcare form assembly of claim 2 wherein the strip or section of the layer of the deadening material is disposed between the release coating and the adhesive layer.

6. The healthcare form assembly of claim 1 wherein the weakened separation line includes a plurality of cuts and a plurality of ties.

7. The healthcare form assembly of claim 1 wherein at least one of the plurality of apices is adjacent to an edge of a removable strip.

8. The healthcare form assembly of claim 1 wherein the weakened separation line is free of ties at at least one of the plurality of apices.

9. The healthcare form assembly of claim 1 wherein at least one of the plurality of apices has a shape selected from the group consisting of rounded, square, rectangular, trapezoid, elliptical, and triangular.

10. The healthcare form assembly of claim 1 wherein the carrier sheet defines an edge and the weakened separation line of the carrier sheet includes a tie at the carrier sheet edge.

11. The healthcare form assembly of claim 1 wherein the carrier sheet defines a notch adjacent to the weakened separation line defined in the carrier sheet.

12. The healthcare form assembly of claim 1 wherein the printable sheet includes a weakened separation line.

13. A healthcare form assembly comprising:
a carrier sheet including a release coating on the carrier sheet;
an adhesive layer disposed on the release coating;
a printable facestock sheet having a same or substantially the same shape as the carrier sheet and being removably disposed on the carrier sheet, the printable facestock sheet defining a plurality of cut lines to thereby form a collection of removable strips, the collection of removable strips including at least a first strip and a second strip;
wherein the first strip and the second strip are adjacent to one another and are separated by a cut in the printable facestock sheet, the cut in the printable facestock sheet defining at least a portion of the shape of the first strip and at least a portion of the shape of the second strip, the carrier sheet defining a weakened separation line that extends under the first strip and the second strip, the healthcare form assembly configured to be torn by a user along the weakened separation line, and thereby remove a portion of the carrier sheet from portions of both the first strip and the second strip, thereby leaving a portion of the adhesive layer of both the first strip and the second strip exposed.

14. The healthcare form assembly of claim 13 wherein after tearing along the weakened separation line, a majority portion of both the first strip and the second strip remain adhered to another portion of the carrier sheet.

15. The healthcare form assembly of claim 13 wherein the healthcare form assembly is configured to be placed on a flat surface after the separation of the portion of the carrier sheet from the first strip without creating an adhesive bond between the first strip and the flat surface.

16. The healthcare form assembly of claim 13 wherein the weakened separation line extends parallel to at least one edge of both the first strip and the second strip.

17. The healthcare form assembly of claim 16 wherein the weakened separation line is spaced from the edge of both the first strip and the second strip.

18. The healthcare form assembly of claim 13 wherein the weakened separation line underlies a cut line in the printable facestock sheet.

19. The healthcare form assembly of claim 13 wherein the weakened separation line is a straight line.

20. The healthcare form assembly of claim 13 wherein the weakened separation line includes a plurality of apices.

21. The healthcare form assembly of claim 13 wherein the carrier sheet defines an edge and the weakened separation line includes a tie at the carrier sheet edge.

22. The healthcare form assembly of claim 13 wherein the printable facestock sheet includes a weakened separation line.

23. The healthcare form assembly of claim 22 wherein the weakened separation line of the printable facestock sheet is at least substantially parallel to the weakened separation line of the carrier sheet.

24. The healthcare form assembly of claim 13 wherein the weakened separation line in the carrier sheet includes a plurality of cuts and a plurality of ties.

25. The healthcare form assembly of claim 13 wherein the carrier sheet defines a notch adjacent to the weakened separation line defined in the carrier sheet.

26. The healthcare form assembly of claim 13 wherein the printable facestock sheet defines at least one cut line extending substantially parallel to an edge of the printable facestock sheet and spaced from the edge of the printable facestock sheet to thereby define a peel zone along the edge of the printable facestock sheet, the healthcare form assembly also comprising a strip or section of a layer of a deadening material disposed in the peel zone.

27. A healthcare form assembly comprising:
a carrier sheet defining a leading edge and a trailing edge which are generally parallel to one another, and a first side edge and a second side edge that are generally perpendicular to the leading edge;
a release layer disposed on the carrier sheet;
an adhesive layer disposed on the release layer;
a printable sheet releasably disposed on the carrier sheet, the printable sheet defining a leading edge and a trailing edge which are generally parallel to one another, and a first side edge and a second side edge that are generally perpendicular to the leading edge of the printable sheet, the printable sheet defining a collection of cut lines extending substantially parallel to one of the first side edge and the second side edge of the printable sheet, thereby defining a plurality of removable adhesive strips;
wherein the carrier sheet also defines at least one weakened separation line extending under at least a portion of the removable strips.

28. The healthcare form assembly of claim 27 wherein the weakened separation line includes a plurality of apices.

29. The healthcare form assembly of claim 27 wherein the weakened separation line is a straight line.

30. The healthcare form assembly of claim 27 wherein the weakened separation line includes a plurality of cuts and a plurality of ties.

31. The healthcare form assembly of claim 27 wherein the weakened separation line of the carrier sheet includes a tie at the carrier sheet edge.

32. The healthcare form assembly of claim 27 wherein the carrier sheet defines a notch adjacent to the weakened separation line defined in the carrier sheet.

33. The healthcare form assembly of claim 27 wherein the weakened separation line is spaced from at least one edge of a removable strip.

34. The healthcare form assembly of claim 27 wherein the weakened separation line underlines a cut line in the printable sheet.

35. The healthcare form assembly of claim 27 wherein
the printable sheet also defines another set of cut lines extending substantially parallel to the leading edge of the printable sheet to thereby create a first peel zone along the leading edge of the printable sheet and another set of cut lines extending substantially parallel to the leading edge of the printable sheet to thereby create a second peel zone spaced from the first peel zone.

36. The healthcare form assembly of claim 35, the healthcare form assembly also comprising at least one section of a layer of deadening material disposed in at least one of the first and second peel zones.

37. The healthcare form assembly of claim 27 wherein the distance between the leading edge of the carrier sheet and the trailing edge of the carrier sheet defines a carrier sheet length, the distance between the first side edge of the carrier sheet and the second side edge of the carrier sheet defines a carrier sheet width, and the carrier sheet length is greater than the carrier sheet width.

38. The healthcare form assembly of claim 27 wherein the distance between the leading edge of the printable sheet and the trailing edge of the printable sheet defines a printable sheet length, the distance between the first side edge of the printable sheet and the second side edge of the printable sheet defines a printable sheet width, and the printable sheet length is greater than the printable sheet width.
